(19) United States
(12) Patent Application Publication
(10) Pub. No.: US 2025/0180497 A1
(43) Pub. Date: Jun. 5, 2025

(54) IMPROVED SURFACE ANALYSIS PROCESS AND DEVICE

(71) Applicant: PHOTOELECTRON INTELLECTUAL PROPERTY HOLDINGS LLC, Sheridan, WY (US)

(72) Inventor: Peter Cumpson, Crow's Nest, New South Wales (AU)

(21) Appl. No.: 18/689,402

(22) PCT Filed: Sep. 5, 2022
(86) PCT No.: PCT/GB2022/052256

§ 371 Date: Mar. 5, 2024

(30) Foreign Application Priority Data
Sep. 5, 2021 (AU) 2021902871
Jul. 10, 2022 (AU) 2022901921
Jul. 30, 2022 (AU) 2022902144

(51) Int. Cl. G01N 23/2273; G01N 23/2202

(52) U.S. Cl. CPC G01N 23/2273; G01N 23/2202; G01N 2223/085; G01N 2223/1016

(57) ABSTRACT

A process for producing x-ray photoelectron spectra of a sample comprising the steps of: producing a plurality of different oxidation states of the sample in a surface thereof by exposing the sample surface to an agent configured to change the oxidation state of said sample surface; placing the sample in an x-ray photoelectron spectroscopy apparatus; obtaining an x-ray photoelectron spectra for each of the plurality of oxidation states of the said sample surface; identifying materials within the sample by analysing the plurality of spectra.

### CROSS-REFERENCE TO RELATED APPLICATION(S)

This application is the national phase of PCT Application No. PCT/GB2022/052256 filed on Sep. 5, 2022, which claims priority to Australian Application No. 2021902871 filed on Sep. 5, 2021, Australian Application No. 2022901921 filed on Jul. 10, 2022, and Australian Application No. 2022902144 filed on Jul. 30, 2022, all of which are incorporated by reference herein in their entireties.

### TECHNICAL FIELD

The present disclosure relates to Chemical and Physical Analysis of materials using x-ray photoelectron spectroscopy.

### BACKGROUND

In analytical laboratories there is a frequent need to characterize small samples chemically. Techniques such as x-ray photoelectron spectroscopy (XPS) 1 and secondary ion Mass spectrometry (SIMS) can provide an excellent chemical characterization of the top few nanometers of the surface. See an example of an XPS instrument in FIG. 1, and a view through a viewport into one in FIG. 2. A schematic cross-section of a typical commercial XPS instrument is shown in FIG. 15.

Throughout this document, when referring to x-ray photoelectron (XPS) spectra I include x-ray induced Auger peaks, which appear in the same spectra from XPS instruments. The present disclosure should be equally valuable for elucidating the chemical components of these Auger peaks as strictly photoelectron peaks. The terms “sample” and “specimen” are used interchangeably throughout.

In XPS the energy resolution is typically limited in a lab-based instrument (as compared to a synchrotron for example). In the last two decades there has been a trend towards monochromated x-ray sources in XPS, so that whereas simple anode x-ray sources were popular in the 1980s, nearly all new XPS instruments have a monochromator to improve energy resolution, expensive though such monochromators are.

The reason analysts require more energy resolution is to distinguish different chemical states in the core-level peaks in a sample. In a recent poll on the Linkedin social network, the results of which are shown in Table 1, XPS users ranked peak fitting (i.e. resolving the different chemical states within an XPS peak) as the biggest problem for them in XPS.

TABLE I
Poll results from a LinkedIn poll of XPS users in 2021
Evidence that curve-fitting is the biggest problem for XPS users
Responses to a 2021 survey on the LinkedIn social network
(48 responses from XPS users) to the question:
What is the most challenging part of performing XPS analysis?

| | |
|---|---|
| Curve fitting XPS spectra | 44% |
| Homogeneous samples analysis | 27% |
| Charging issues | 15% |
| Accurate data quantification | 15% |

Increased energy resolution helps minimize such a peak overlap in core-level peaks, and there have been technical improvements over the years to make this easier in commercial instruments.

However, there are many cases in which it cannot be avoided. To improve energy resolution in the hemispherical electron energy analyzer one must choose a large analyzer (which is expensive) and/or move to a lower pass energy in that analyzer, which reduces the count rate and can lead to noisy spectra. Much of the skill of operating an XPS system lies in choosing the right parameters for pass energy (in eV) and spectrum channel interval (in eV) and channel dwell time (in seconds, s) to give spectra with the required resolution to resolve peaks but show good spectral signal-to-noise.

Even so, there are many cases in which peaks are not resolved and this is recognized as a big problem in the surface analytical community. This problem has been discussed at length in the literature in recent years, for example by Baer et al². Based on an extensive review of 409 published papers Major et al³ say that “more than 65% of the papers showing XPS spectra also showed some degree of fitting and this was the source of the majority of errors”. This is the most significant problem facing a sizable international analytical community: XPS allows erroneous peak attribution and intensity measurements unless peak parameters and linkages are chosen skillfully by the analyst. Major et al⁴ noted that “High-resolution spectra of transition metals are among the most challenging spectra to peak fit. Indeed, it is common to see peak fitting of transition metals that oversimplify assignments of peaks to individual chemistries and subsequently have erroneous interpretations of results”. Yet transition metals are extremely important technologically, with elements like Hf and Ta being very important in semiconductor surface analysis and a wide range of these elements important in battery technology. In FIG. 21 I show (taken from Wikipedia) the oxidation states of the transition metals. The solid dots show common oxidation states, and the hollow dots show possible but unlikely states. This figure makes very clear that the transition metals can be found in many oxidation states in many possible compounds, with core-level spectra from those transition metal elements overlayed in the XPS spectrum in a very confusing way for all but the most skilled analysts.

Many analysts are trying their best with moderate skill, but peak fits to such poorly resolved peaks are often criticized in the literature as being wrong and misleading.

The usual cause of plural unresolved peaks in a narrow XPS spectrum is that the surface contains plural oxidation states of one or more elements or compounds. In principle one could tabulate the binding energies of all chemical states of an element. This is a good first guide, and analysts often look at the NIST database⁵ when dealing with particular elements. To use this method exclusively, though, is a real challenge, because;
1. Some oxidation states of some elements are not in the databases.
2. The binding energies have been acquired over a long period of time, by many different people using many different instruments, and their binding energy calibration procedures can be uncertain.
3. A small error in the binding energy of a peak (say one that lies unresolved between two other peaks in the spectrum) can lead to a large error in the relative intensities of those three peaks. Even 0.1 eV error in binding energy—the absolute limit of what is currently achievable even with repeated and expensive calibration steps—can lead to large uncertainties in the relative intensities of adjacent, unresolved peaks in the spectrum.

Therefore, some kind of “internal” reference or method would be very useful. In other words, some way of altering the relative intensities of the different unresolved peaks away from their nominal values. Sometimes this can be achieved by tilting the specimen-which, if the different chemical states exist at different depths, can achieve this. Often they don't occur at different depths because the sample surface is fairly homogeneous. Plus, tilting is often not easy in modern instruments with large sample holders⁶. Also, tilting can change the inelastic background under the peaks, which adds more complication to peak-fitting.

One technique which can prove useful is to lightly or briefly sputter the surface with energetic ions (most XPS systems have an ion gun installed to allow sputter depth profiling). This introduces damage, often removing some oxidized species close to the surface, or chemically reducing the oxidation state of other species. It can be useful to compare narrow-scan spectra containing overlapping chemical states before and after this brief sputtering. However, this has limitations; run the sputter gun for too long and all chemical states from the surface will be removed leaving the spectrum of damaged bulk material. This is easy to do because these guns are designed to remove material quickly. Worse, if there is little to be chemically reduced at the surface, then reducing it further by sputtering changes the spectra little and tells one little about the peaks present (one would want to oxidise instead).

Nevertheless, brief sputtering is often useful and can be done quickly in the XPS analytical chamber itself. In a sense it is the opposite process to that of the present disclosure, so that the two can be usefully combined, indeed, the spectra from both could be usefully analyzed within the same principal component analysis⁷ (PCA), singular value decomposition⁸ (SVD), or Non-negative Matrix Factorization (NMF) method.

Ironically, as the speed of commercial XPS systems has increased, more spectra are generated each year, but there are only a limited number of skilled personnel to interpret them. The costs of XPS analysis are shifting from the cost of instrument time to the cost of interpretation (in many cases involving in peak-fitting). One of the features of the present disclosure described here is that (by generating more spectra that remove the ambiguities that would exist if only one were recorded) it uses extra instrument time (which is cheap) to reduce the analyst's time spent on interpretation (which is expensive) and improves reliability of the result and improves the ability to demonstrate that the correct conclusions have been reached to readers of analytical reports and scientific publications.

Using UV light and ozone to oxidize the surface of a sample can provide more information on the surface chemistry (specifically the XPS peak shape(s)) than can be obtained from a spectrum in the “as-received” state alone. For many types of specimen this works very well. For some, especially those for which the material within the XPS sampling depth is already at, or near, its highest oxidation state, exposure to UV and ozone can change those oxidation states little. Therefore, in the present disclosure I describe both oxidation and reduction as options for sample surfaces, so that the XPS spectra from even such initially oxidized samples can be elucidated by the multivariate methods mentioned above.

UV-assisted reduction of copper oxides in a hydrogen atmosphere has been demonstrated⁹ using XPS, though for different purposes to the present disclosure, and within a suitable timescale to apply as an analytical method for a range of sample types, being in this case around ten times faster in the presence of hydrogen than with 254 nm UV exposure alone. UV-assisted reduction of graphene oxide has been demonstrated¹⁰ for different purposes to the present disclosure, but nevertheless suggesting that UV-assisted reduction of a sample surface may be useful in XPS for carbonaceous materials in addition to transition metals.

Rather than simply navigate a linear path between oxidation and reduction, there is evidence that UV exposure can cause unusual oxides (i.e. those that would not normally be expected even after extended time at room or elevated temperatures in air) to be formed¹¹ (e.g. for Ni, or for semiconductor surfaces¹²) which displace others—this is extremely helpful in elucidation of peak structures in XPS.

U.S. Pat. No. 7,875,857 describes an x-ray photoelectron spectroscopy analysis system for surface analysis and a method therefor.

U.S. Pat. No. 7,420,163 describes the use of photoelectron spectroscopy for determining layer thickness.

U.S. Pat. No. 5,315,113 describes an instrument for surface analysis using scanning and high resolution x-ray photoelectron spectroscopy and imaging.

### SUMMARY

According to a first aspect of the present disclosure there is provided a process for producing x-ray photoelectron spectra of a sample comprising the steps of:
producing a plurality of different oxidation states of the sample in a surface thereof by exposing the sample surface to an agent configured to change the oxidation state of said sample surface;
placing the sample in an x-ray photoelectron spectroscopy apparatus;
obtaining an x-ray photoelectron spectra for each of the plurality of oxidation states of the said sample surface;
identifying materials within the sample by analyzing the plurality of spectra.

Preferably, the sample is exposed to the agent configured to change the oxidation state of the said surface of the sample a plurality of times sequentially, wherein in each subsequent exposure of the sample to the agent, the oxidation state of the surface of the sample is changed relative to the oxidation state of the sample surface resulting from the preceding exposure to the agent configured to change the oxidation state of the said sample surface.

The sample may be divided into a plurality of sub-samples each having a sub-sample surface, and wherein a different oxidation state of the sub-sample surface is produced for each sub-sample.

The agent configured to change the oxidation state of the sample surface may be a gaseous agent.

The agent configured to change the oxidation state of the sample surface may be one or more of: ultraviolet light, ozone and hydrogen.

Advantageously, ultraviolet light is provided by at least one ultraviolet (UV) lamp, wherein UV light emitted from the at least one UV lamp is directed at said sample surface.

The UV light emitted from the at least one UV lamp may be in the wavelength range 200 nm to 300 nm.

For oxidation of the sample surface ozone is necessary. Oxidation is faster with optional UV in the wavelength range 200 to 300 nm. For many sample materials, reduction of the sample surface could be achieved slowly with UV, in the wavelength range 200 to 300 nm, alone provided it was done in vacuum, or about 10 times faster with hydrogen present.

Preferably, the UV lamp is a mercury vapor lamp.

Ozone may be provided by an ozone-producing device producing ozone gas at concentration in the range 0.01 to 20 parts-per-million in the gas around the said specimen.

The process may include the step of controlling the degree of change of the oxidation state of said sample surface by controlling one or more of: the time of exposure of the said sample surface to the agent; the concentration of the agent; and the wavelength and/or frequency of the agent.

The step of identifying materials within the sample by analyzing the plurality of spectra may include performing multivariate analysis, for example, principal component analysis or non-negative matrix factorization.

According to a second aspect of the present disclosure there is provided a device for capturing x-ray photoelectron spectra (XPS) configured to perform the process of the first aspect of the present disclosure, comprising:
a sample holder;
a source of the agent configured to change the oxidation state of a surface of a sample held in the sample holder;
means to control exposure of the sample surface to the agent configured to change the oxidation state of said surface; and
an x-ray photoelectron spectrometer capable of recording a plurality of XPS spectra one for each oxidation state of the sample surface.

The device may further comprise a data processor configured to perform principal component analysis.

Preferably, the sample holder of the device is contained in an enclosure.

The agent configured to change the oxidation state of the sample surface may be a gaseous agent.

The agent configured to change the oxidation state of the sample surface may be one or more of: ultraviolet light, ozone and hydrogen.

The ultraviolet light may be provided by at least one ultraviolet (UV) lamp, wherein UV light emitted from the at least one UV lamp is directed at said sample surface.

Preferably, the UV light emitted from at least one UV lamp is in the wavelength range 200 nm to 300 nm.

The at least one UV lamp may be a mercury vapor lamp.

The device may further comprise an ozone generator configured to release ozone around a sample situated in the sample holder.

The ozone generator may be a UV lamp emitting UV light in the wavelength range 100 nm to 300 nm.

Advantageously, the UV lamp of the ozone generator may emit ultra-violet light at 185 nm and/or 254 nm. Advantageously, the UV lamp of the ozone generator is a mercury vapor lamp.

The device may further include a hydrogen source configured to release hydrogen around the sample in the sample holder.

Advantageously, the hydrogen source is at least one zinc-air cell.

Preferably, the zinc-air cell operates in the absence of oxygen, for example in a partial vacuum.

The sample holder may be adapted to hold a plurality of sub-samples, each sub-sample having a surface with a different oxidation state, and wherein the x-ray photoelectron spectrometer is configured to record XPS spectra for each of the sub-samples.

### BRIEF DESCRIPTION OF THE DRAWINGS

In the Drawings, which illustrate preferred embodiments of the present disclosure, and which are by way of example:

FIG. 1 is a typical commercial XPS instrument. Note the stainless-steel ultra high vacuum (UHV) chamber and ports. The computer running the system is not shown here;

FIG. 2 is a typical view through a viewport into a system similar to that shown in FIG. 1;

FIG. 3 is a Computer Aided Design view of one type of commercial sample holder and the disc-shaped sample “stub” that fits into it;

FIG. 4: Another commercially-available sample holder, this time from a Thermo KAlpha XPS instrument. In normal operation this sample block is transported through the instrument in Ultra High Vacuum (UHV) to the analytical position;

FIG. 5: Schematic diagram of one embodiment of the UV/ozone or UV/hydrogen exposure apparatus in this disclosure;

FIG. 6: Schematic diagram showing how oxidative species are created and react with the specimen (substrate) surface during UV/ozone cleaning;

FIG. 7: General procedure for using the spectrum acquisition usage of this disclosure; UV/ozone option;

FIG. 8: UV/ozone exposure of carbonaceous contamination on a surface-XPS spectra over increasing periods of exposure;

FIG. 9 illustrates synthetic spectrum with three identical component peaks at binding energies of 1.5, 2.5 and 3.5 eV;

FIG. 10 illustrates synthetic spectra for increasing number of UV/ozone exposure steps from (a) to (f);

FIG. 11 illustrates results of singular value decomposition (SVD) of the spectra shown FIG. 10;

FIG. 12 illustrates three synthetic component peaks as in FIG. 9, but with reduced energy separation. These are at 2 eV, 2.SeV and 3 eV, but if one did not know this one would be hard-pressed to judge how many peaks were really under this envelope and what energies or widths they may have;

FIG. 13 illustrates synthetic spectra based on the model of three closely-separated peaks shown in FIG. 12;

FIG. 14 illustrates results of Singular Value Decomposition (SVD) applied to the spectra shown in FIG. 13. The numeric labels indicate the center of the respective peak, as measured by fitting a parabola to the five values around the maximum;

FIG. 15 illustrates a configuration of a typical commercial XPS instrument for use with the present disclosure;

FIG. 16 illustrates one configuration of the present experiment in which the sample is moved, in air, from an XPS system to an enclosure (1610) containing the UV/ozone or UV producing lamps and hydrogen (1620);

FIG. 17 illustrates another configuration of the present disclosure, in which the enclosure containing UV/ozone is integrated with the XPS system entry lock. This requires a UV-transparent window on said entry lock and the back-fill gas cylinder (1700) to contain oxygen or an oxygen containing gas mixture (e.g. air);

FIG. 18 illustrates a typical UV lamp type GTL3;

FIG. 19 illustrates a typical high-power LED UV emitter with an emission wavelength around 270 nm. These are sold for water sterilization in pools and baths;

FIG. 20 illustrates the Hartley absorption band of ozone. Note that the 254 nm emission from low-pressure mercury vapor lamps is near the top of this absorption features—in the ozone spectrum;

FIG. 21 illustrates oxidation states available to elements of progressively higher atomic number. Filled circles represent common oxidation states, while empty circles represent uncommon ones;

FIG. 22 illustrates XPS spectra in the Ti2p region for Electrical Potential Marker Particles (EPMPs) deposited on two different insulating polymers, (a) and (b). Although these spectra were taken on the same (Thermo k-Alpha model) instrument only minutes apart, notice that the larger Ti 2p_{3/2} peak has a slightly different apparent energy with respect to the instrument energy scale due to the establishment of a slightly different charge balance potential in the two cases;

FIG. 23 is a schematic illustration shown how Electrical Potential Marker Particles (EPMPs) are deposited by ion-beam sputtering;

FIG. 24 illustrates the general procedure for using the spectrum acquisition usage of this disclosure for reducing a sample surface. Here the “hydrogen containing chamber” is the same as the sample enclosure discussed in the text, when filled with hydrogen;

FIG. 25 illustrates synthetic spectrum with three identical component peaks at binding energies of 1.5, 2.5 and 3.5 eV;

FIG. 26 illustrates synthetic spectra for increasing number of UV/hydrogen exposure steps from (a) to (f);

FIG. 27 illustrates results of singular value decomposition (SVD) of the spectra in FIG. 26;

FIG. 28 illustrates three synthetic component peaks as in FIG. 25, but with reduced energy separation. These are at 2 eV, 2.5 eV and 3 eV, but if one did not know this one would be hard-pressed to judge how many peaks were really under this envelope and what energies or widths they may have;

FIG. 29 illustrates synthetic spectra based on the model of three closely-separated peaks shown in FIG. 28;

FIG. 30 illustrates results of Singular Value Decomposition (SVD) applied to the spectra shown in FIG. 29. The numeric labels indicate the center of the respective peak, as measured by fitting a parabola to the five values around the maximum;

FIG. 31 is a product overview of two hydrogen-producing “button” cell batteries from the Varta company;

FIGS. 32(a) and 32(6) illustrate one embodiment of hydrogen production apparatus. In (a) the switch is open and no hydrogen is being produced by the button cells, 720, or passing through the sealed palladium/palladium alloy tube 730. Under the control of the programmable logic controller, 750, if the switch is closed (as shown in (b)) a current flows through the cells determined in advance by the value of resistor R, causing hydrogen production. Hydrogen permeates through the said sealed Pd/Pd alloy tube;

FIG. 33 illustrates one possible simple embodiment B of the cell enclosure;

FIGS. 34(a) and 34(6) illustrate schematics of one possible embodiment of the cell-enclosure type B (incorporating a pressure relief valve). The labelled “inside enclosure” space is the sample enclosure, whereas 930 is the cell-enclosure. In this figure (a) dormant and (b) hydrogen-producing states are shown; and

FIG. 35 illustrates an embodiment where a sample is divided into sub-samples.

FIG. 36 illustrates another configuration of the present disclosure, in which the enclosure containing UV producing lamps and hydrogen is integrated with the XPS system entry lock. In particular the optional hydrogen-producing cells are shown here (1780).

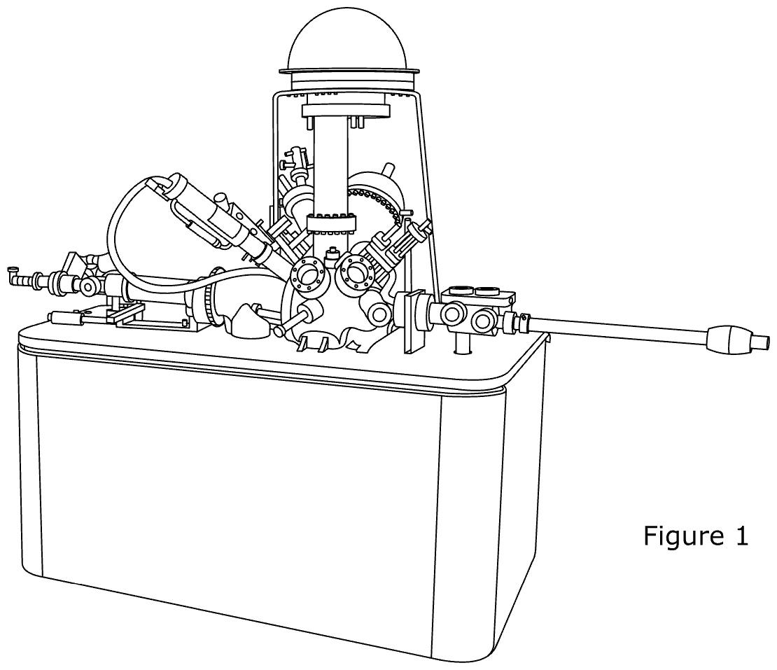

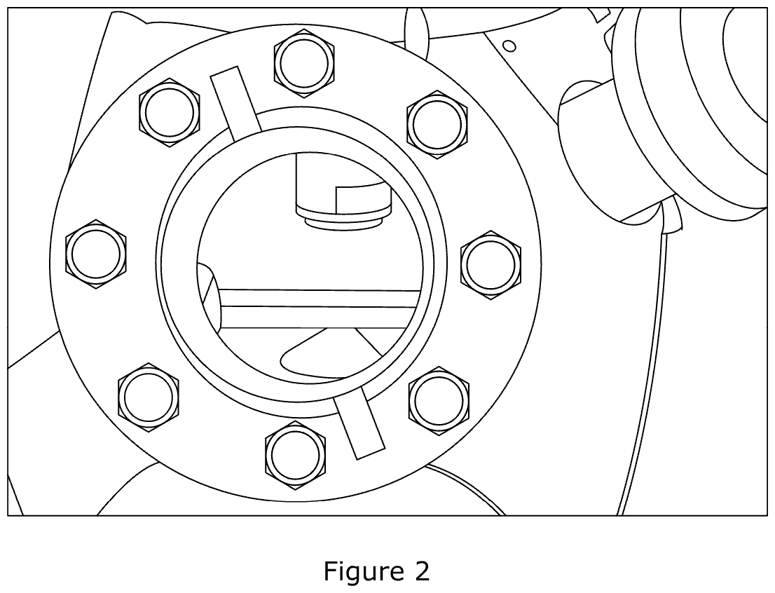

### DETAILED DESCRIPTION

The present disclosure increases the reliability and accuracy of XPS peak fitting by chemically modifying the surface being analyzed either by oxidation or reduction. Oxidation employs ultraviolet light and/or ozone in the presence of oxygen-containing gas (e.g. lab air), thereby changing the proportions of the different chemical states at the surface, for example by increasing the proportion of highly oxidized states. Reduction employs exposure to ultraviolet light with optional hydrogen gas. By comparing XPS spectra recorded before and after this step (and optionally more than one such reduction/oxidative step) it extracts the component peaks in the spectrum numerically in a computer, for example using multivariate statistical methods (in some embodiments Principal Component Analysis (PCA), non-negative matrix factorization (NMF) or Singular Value Decomposition (SVD)). This UV/ozone exposure/hydrogen exposure/XPS spectrum acquisition cycle is done over a short time period and using the same XPS settings, so that drift of the XPS energy scale is negligible.

The device of the present disclosure may comprise;
1. An enclosure composed of materials that UV and ozone do not easily attack (e.g. metals, glass). It has a door or lid that is easy to open and close, and is largely (though not necessarily completely) airtight when the door or lid is closed. The door or lid, when open, permits the insertion of a sample holder.
2. A sample holder, in some embodiments of the type designed to hold common sample stub types used in electron microscopy and surface analysis.
3. Within the said enclosure, or directed inwards from outside through a UV-transmitting window, are one or more sources of UV light, preferably at least one of which is capable of emitting significant radiation at a sufficiently short wavelength to produce ozone in air at room temperature and pressure. In some embodiments these are mercury vapor lamps 13, and in others short wave light emitting diodes (LEDs), or a combination of the two.
4. An electronic circuit that switches on the light source(s) for a predetermined time or to a pre-determined ozone concentration, or until a predetermined exposure of the sample holder to UV and/or ozone has been reached;
5. The ozone and/or UV produced within the enclosure are at sufficient levels to chemically modify the specimen surface, so that the envelope of chemical states seen in XPS spectra is changed by this exposure, but sufficiently low that no elements (even carbon) are completely removed.
6. Optionally sensors for the measurement of UV and/or ozone concentration within the said enclosure. These allow the UV and ozone levels to be reported to the user, so that repeatable and reproducible exposure of specimens to UV and ozone are possible, in some embodiments even under closed-loop (e.g. proportional-integral-derivative or PID) control.
7. Optionally the use of Electric Potential Marker Particles (EPMPs) for accurate charge referencing in those cases where the sample is not a good electrical conductor.
8. An x-ray photoelectron spectroscopy (XPS) instrument capable of recording XPS narrow-scan spectra of the type normally used for XPS peak-fitting.
9. Computer processing of the resulting XPS spectra by a multivariate method such as Singular Value Decomposition, non-negative matrix factorization or Principal Component Analysis to identify the components of the spectra that vary together.

The said enclosure can be entirely separate from the vacuum system, or form part of it (e.g. the entry-lock of the XPS system, so that the sample block never leaves the automated sample handling system of the XPS instrument). Ultraviolet (UV) and ozone production is achieved using small mercury lamp(s). Optionally the ozone is augmented from an external electrical ozone generator. Ozone is produced in-situ from diatomic oxygen in air by illumination with very short wavelength UV light, in one embodiment 185 nm radiation from a mercury vapor lamp. Destruction of the ozone to allow the container to be opened is achieved by illuminating the contained air with longer wavelength UV, in one embodiment 254 nm radiation from a mercury vapor lamp (where the shorter 185 nm emission has been blocked by a glass envelope or filter). FIG. 5 shows schematically one embodiment of this part of the present disclosure.

In FIG. 5 a battery or mains power supply (630) supplies energy to one of two UV lamps (640) labelled A and B. Both lamps, in this embodiment, are mercury vapor lamps. Both emit energy in the UV at both 185 nm and 254 nm. Lamp B has an optical filter (610) covering it so that only the longer of these two wavelengths reaches the air around the sample. A Programmable timer controls which lamp (if either) receives power. In each case a “ballast” component (620) is required (as for most discharge lamps and fluorescent lamps) to manage the voltage and current of the lamp through an acceptable range as it begins to operate-often initially a high voltage is applied to establish the discharge then a lower voltage and current to maintain it. The programmable timer, in this embodiment, powers the lamp A (illuminating the sample with UV light and forming ozone around it) then switches off lamp A and switches on lamp B (from which only 254 nm radiation is able to reach the space around the sample, decomposing what ozone remains) then finally switches both lamps off. This ensures that all ozone is quickly removed from the enclosure so that the sample can quickly and safely be put into the XPS analysis chamber. In some embodiments the sample is on a slowly rotating stage, so as to homogenize the exposure to UV and ozone.

### Reduction of the Surface Layer

Another aspect of the present disclosure increases the reliability and accuracy of XPS peak fitting by chemically modifying the surface being analyzed using ultraviolet light and/or hydrogen gas, thereby changing the proportions of the different chemical states at the surface, for example by reducing the proportion of highly oxidized states. By comparing XPS spectra recorded before and after this UV and/or hydrogen exposure step (and optionally more than one such redox step) it extracts the component peaks in the spectrum numerically in a computer, for example using multivariate statistical methods (in some embodiments Principal Component Analysis (PCA), non-negative matrix factorization (NMF) or Singular Value Decomposition (SVD)). This UV/hydrogen exposure/XPS spectrum acquisition cycle is done over a short time period (typically less than a day) and using the same XPS settings, so that drift of the XPS energy scale is negligible.

The device of the present disclosure may comprise;
1. A sample enclosure composed of materials that UV and hydrogen do not easily attack (e.g. appropriate metals, glass). It has a door or lid that is easy to open and close, and is largely (though not necessarily completely) airtight when the door or lid is closed. The door or lid, when open, permits the insertion of a sample holder.
2. A sample holder, in some embodiments of the type designed to hold common sample stub types used in electron microscopy and surface analysis.
3. Within the said enclosure, or outside the sample enclosure but directed into it through an optical window, are one or more sources of UV light, preferably at least one of which is capable of emitting significant radiation at a sufficiently short wavelength to assist in photo-catalytically aiding the reduction of sample surfaces in the presence of hydrogen gas. In some embodiments these are mercury vapor lamps¹³, or other kinds of discharge lamps such as xenon lamps, and in others short wave light emitting diodes (LEDs), or a combination of these.
4. Oxygen is removed from the sample enclosure, optionally by pumping the air out of the sample enclosure to reach pressures in the range below 10⁻³ millibar, and preferably below 10⁻⁶ millibar. Alternatively, the sample enclosure may be purged with an inert gas such as nitrogen or argon.
5. Hydrogen gas is introduced into the sample enclosure, optionally from a hydrogen gas generating cell or cells as described later, or optionally from an external hydrogen cylinder.
6. Optionally the zinc-air (or similar) cell or cells (forming a battery) may be fixed within a hydrogen-permeable cell-enclosure¹⁴ (for example a palladium or palladium alloy tube) that allows hydrogen to leave the battery and pass through the wall(s) of the hydrogen-permeable cell-enclosure but prevents other species (such as water vapour) from doing so. Optionally, said permeable cell-enclosure may be heated¹⁵, for example by passing an electric current though it leading to cause Joule-heating, in order to increase the rate of hydrogen diffusion through its walls out into the main space within the sample enclosure containing the sample(s). Instead of a hydrogen-permeable cell-enclosure an impermeable one and pressure relief valve arrangement may be used as described below.
7. Optionally an electronic circuit that switches on a current through the said zinc-air or similar metal-air battery for a predetermined time, or pre-determined total charge passed or to a pre-determined hydrogen concentration, or until a predetermined exposure of the sample holder to UV and/or hydrogen has been reached.
8. The hydrogen and/or UV produced within the sample enclosure are at sufficient levels to chemically modify the specimen surface, so that the envelope of chemical states seen in XPS spectra is changed by this exposure, as more reduced chemical states become more common at the surface.
9. Optionally sensors for the measurement of UV and/or hydrogen concentration within the said sample enclosure. These allow the UV and hydrogen levels to be reported to the user, so that repeatable and reproducible exposure of specimens to UV and hydrogen are possible, in some embodiments even under closed-loop (e.g. proportional-integral-derivative PID) control.
10. Optionally the use of Electric Potential Marker Particles (EPMPs) for accurate charge referencing in those cases where the sample is not a good electrical conductor.
11. An x-ray photoelectron spectroscopy (XPS) instrument capable of recording XPS narrow-scan spectra of the type normally used for XPS peak-fitting.
12. Computer processing of the resulting XPS spectra by a multivariate method such as Singular Value Decomposition (SVD), Non-negative Matrix Factorization (KMF) or Principal Component Analysis (PCA) to identify the components of the spectra that vary together.

The said sample enclosure can be entirely separate from the vacuum system, or form part of it (e.g. the entry-lock of the XPS system, so that the sample block never leaves the automated sample handling system of the XPS instrument). In one embodiment Ultraviolet (UV) light is produced using small mercury lamp(s) and hydrogen from (in one embodiment) a zinc-air (or similar metal-air) cell or cells. Optionally the hydrogen is augmented from an external hydrogen supply or cylinder.

One advantage of using the zinc-air battery instead of a cylinder of hydrogen is that only the very small amount of hydrogen needed is delivered in an (electrically) controllable way, reducing safety concerns that might occur in dealing with larger quantities of hydrogen. Most XPS facilities do not keep a hydrogen cylinder nearby (though a few do). Therefore, the cost of delivering hydrogen safely to the sample surface is greatly reduced by the use of a zinc-air or other metal-air cell.

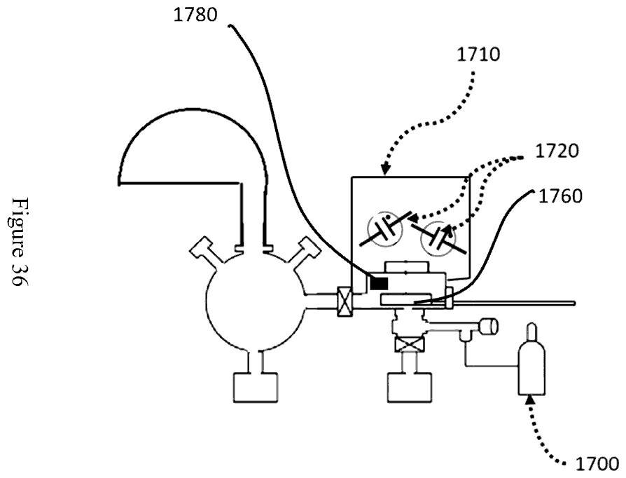

FIG. 36 shows schematically one embodiment of part of the present disclosure.

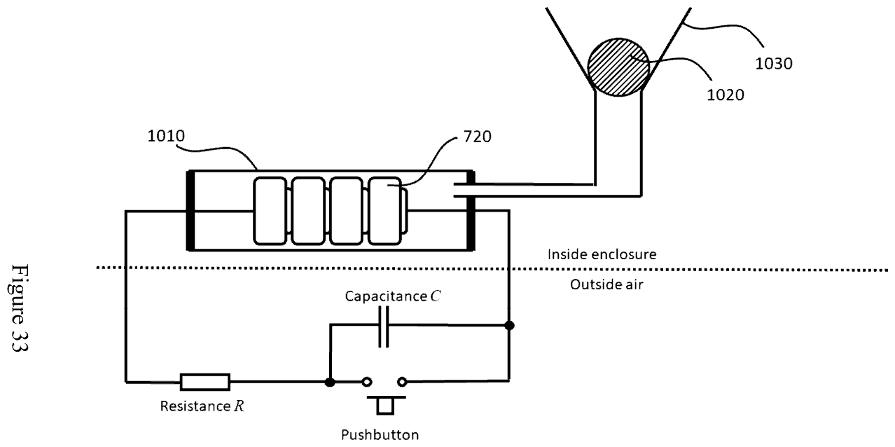

FIGS. 32(a) and (b) show an embodiment in which hydrogen is supplied by zinc-air cells. In FIG. 32 the hydrogen-producing cells, 720, are controlled by the said timer or PLC using a switch or relay, so that when the switch is “on” and current passing through the cells via current-limiting resistor R, said cells produce hydrogen gas at a known, pre-planned rate determined by the value of said resistor R, as shown in FIG. 32(6). A typical value for this resistor is 100 to 300 ohms, but the value is not very critical, the key quantity being the total charge allowed to be passed, which determines the total quantity of hydrogen released.

Comparison with Prior Art

XPS instruments have sometimes been equipped with UV sources over the years, but this has been either to (a) allow ultraviolet photoelectron spectroscopy (UPS) to be performed in vacuum, not to modify the surface in air as in the present disclosure, or (b) to modify particular surfaces in particular chemical ways (e.g. Sun et al¹⁶) using specific types of UV (without hydrogen) to do this, for example long-wave UV at around 365 nm. The aim in this earlier work is not to modify chemical states at the surface for the purpose of identifying chemical states as described in the present disclosure, but to study particular chemical reactions that particular UV exposure induces in particular specimen materials.

UV/Ozone Cleaning Equipments: Why the Present Disclosure is Different to these, and how the Differences Arise from Different Purposes

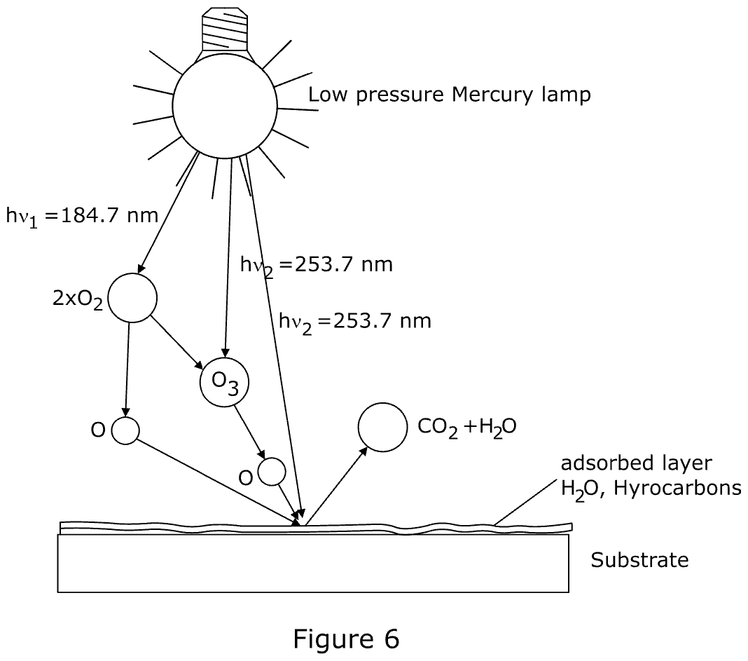

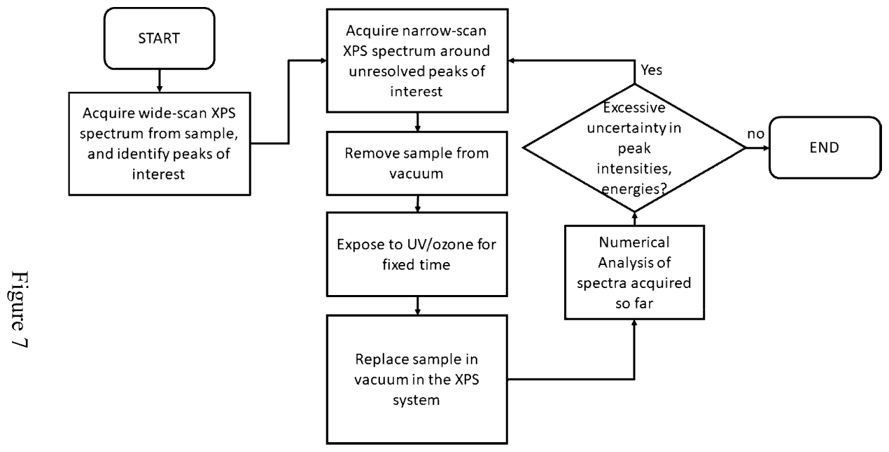

UV/ozone cleaning equipment has been used for several decades, for example as popularized by the work of J R Vig¹⁷, concentrating on the use of mercury vapor lamps. Low-pressure mercury lamps have two principal emissions in the UV, at 185 nm and 254 nm. The 185 nm UV line decomposes oxygen molecules and synthesizes ozone, O3 in situ. The 254 nm UV line decomposes ozone and produces high energy O* (activated oxygen). These highly oxidative species interact with carbonaceous contamination on a surface (indeed, anything on the surface that can be oxidized). Ultimately, in combination with direct UV exposure (interacting strongly with C═O moieties via Norrish type chemical processes) organic species are oxidized and/or degraded to volatile compounds, mostly CO₂, which diffuses away from the surface. This process is shown schematically in FIG. 6.

Commercial UV/ozone cleaners are high-power devices designed to remove all carbonaceous contamination as rapidly as possible. They usually have no need to measure and report UV or ozone levels, instead simply being designed to supply very high levels of both so as to remove contamination rapidly. If surface chemical modification, rather than complete removal of carbonaceous contamination is attempted (for example to clarify chemical shifts in XPS) then it is too easy to go “too far” and remove it all, because of the design aims of the UV/ozone cleaner. There are further differences in design between commercial UV/ozone cleaners and the present disclosure, motivated by the different purpose. Usually commercial UV/ozone cleaners are designed to be used with large objects such as silicon wafers of 200 mm diameter or more. What we need for the present purpose is less power, so that core-level peaks are modified but not completely removed from the XPS spectrum, perhaps over several increasingly aggressive oxidation steps. And a smaller sample space so that the device can be placed close to the XPS sample entry lock, for rapid exposure and then returning the sample to the XPS system vacuum with the minimum of exposure time to atmospheric contamination. UV/ozone cleaning only works for carbonaceous contamination (because it leaves the surface as a gaseous oxide), whereas the present disclosure aims to use UV and/or ozone to oxidize any sample material to remain for XPS analysis afterwards. Also measurements of UV intensity and ozone concentration help in ensuring reproducibility of measurements in different locations, so built-in UV and ozone monitors are useful in the XPS peak fitting application—i.e. they are optional but very useful as part of this disclosure.

Having said all this, I have in the past successfully modified UV/ozone cleaning apparatus to generate spectra for samples UV/ozone exposed. Typically, this has been done by modifying the apparatus, disabling it in some ways (e.g. pressing the “emergency stop” button after a few seconds to avoid excessive UV/ozone exposure) or disassembly to extract components (e.g. the lamp) then putting those components in a different enclosure. Indeed, much of the work that led to the present disclosure was done by modifying commercial UV/ozone units to achieve a purpose for which they were not designed.

Usage Procedure for this Disclosure (Oxidation)

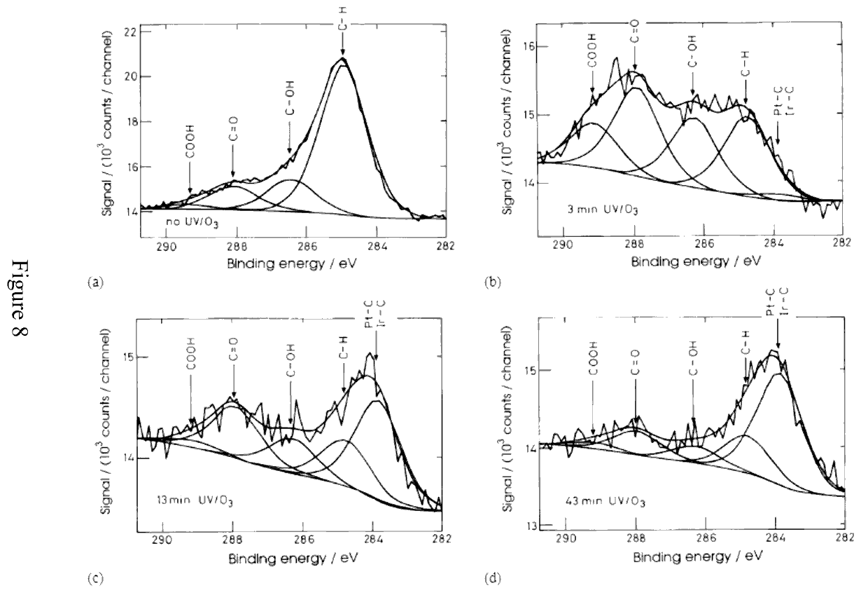

FIG. 7 shows a flowchart for how spectrum acquisition is done with this disclosure. In some cases, the user will have enough information to set the UV/ozone exposure level/time in advance, without applying the question in this flowchart, giving a sequence of exposure steps of predetermined length. Otherwise the computer can, for example, perform PCA analysis of the spectra acquired to that point and recommend an increase to the exposure at the next step to make an observed difference in the spectra more likely.

FIG. 8 shows the result of using UV/ozone exposure and XPS m identifying which chemical state corresponds to which (sometimes unresolved in energy) peak in the XPS spectrum of a carbonaceous layer on a metal. These narrow-scan spectra show the region around the C 1s peaks. The smooth lines have been put in retrospectively as a result of this analysis. Note that since these spectra were acquired in the same instrument within a few hours, the energy scale, and energy resolution, can be regarded as stable.

So UV/ozone exposure causes the height of the peak components to change, but they will not move on the energy scale. Whatever new peak heights that the UV/ozone exposure causes, the fact that they are changed allows them to be extracted from a set of such spectra. For example, in FIG. 8(a) the different oxidation states of carbon are initially poorly resolved. However, (b), (c) and (d) show the intensities of these states changing, and (d) even shows a new carbide state. This has almost the same binding energy as the C*—H peak, and might be misinterpreted as C*—H (which is more common) were it not for being one of a set of spectra (a), (b), (c) and (d) where peak intensities are changing. By the end of this process the binding energies and intensities of the four original states seen in (a) are unambiguously determined.

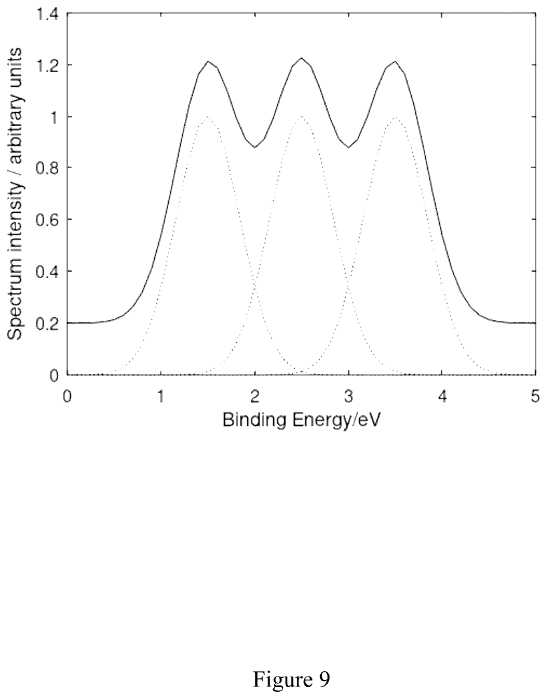

FIGS. 9 to 14 show numerical simulation results that demonstrate the effectiveness of the present disclosure. In FIG. 9, abstracted from the real data shown in FIG. 8, a synthetic spectrum is shown consisting of three peaks 1 eV apart. These can be resolved fairly easily in a modern spectrometer, so looking at the envelope spectrum (the continuous line in FIG. 9) it is clear that there are three peaks here at least. Note that, because C 1s peaks in XPS are typically on a fairly flat background I have included a background 20% of the height of the peaks and it is constant with energy.

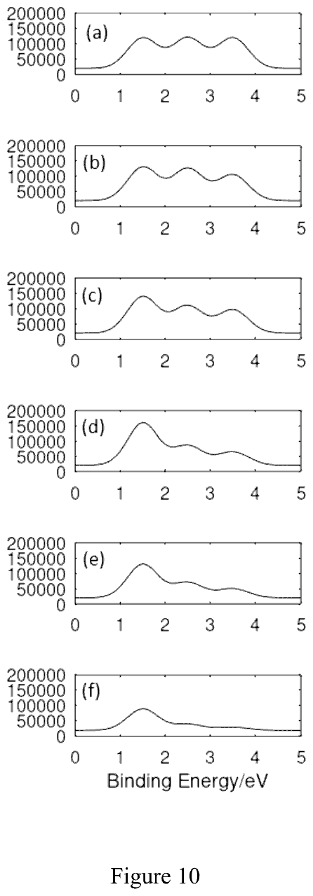

FIG. 10 shows simulated spectra after zero iterations (a), one iteration (b), two iterations (c) and so on of the procedure shown in FIG. 7. Each of 10(b) to 10(f) therefore show the effect of more UV/ozone exposure than the previous one. Some states (i.e. peaks) fall in intensity more rapidly than others as we progress though this series. It does not matter whether the states that are removed more rapidly are at high or low binding energy, simply that the atoms that give rise to a peak in the spectrum can reappear in different chemical state in the next spectrum (or leave altogether, for example as a highly oxidized gas like CO₂).

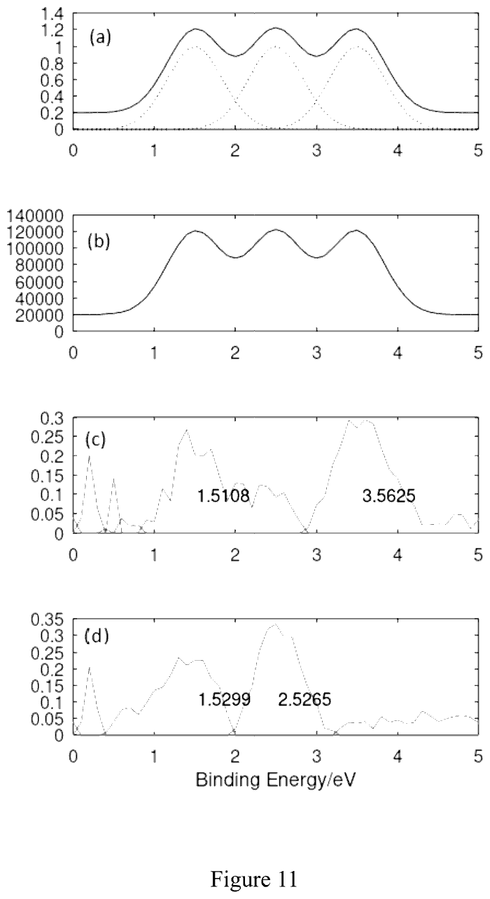

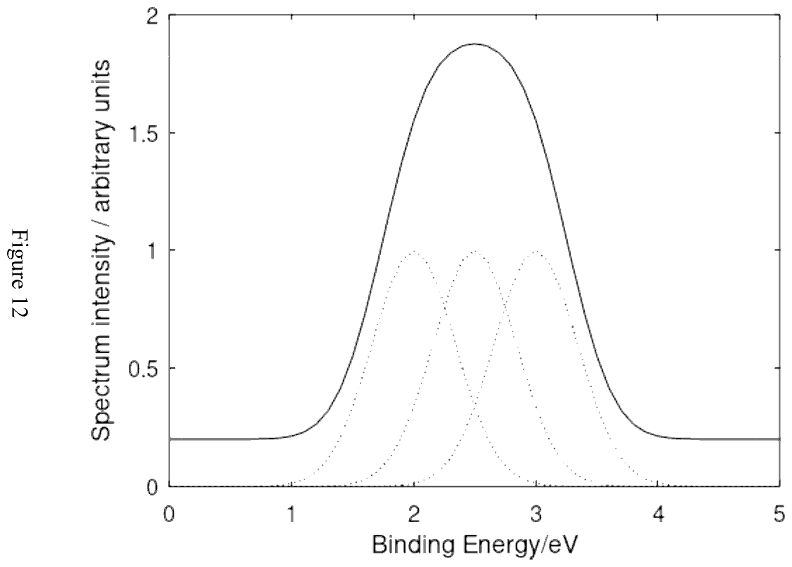

FIG. 11 shows the result of numerical processing of the simulated spectra shown in FIG. 10. FIG. 11(a) is a reminder of the peaks and their envelope as shown in FIG. 9. FIG. 11(b) shows the initial spectrum generated from this model with counts as the vertical axis and Poisson noise added. FIGS. 11(c) and 11(d) show the second and third components extracted from the set shown in FIG. 10 by using Singular Value Decomposition (SVD). The first component is not very useful as it simply resembles the average of the spectra shown in FIG. 10. The second and third (and in other real cases the higher components too) show important peak structures. Here I have inverted the negative parts of these components and plotted them in an unbroken line. The positive parts I have plotted in a dotted line. SVD is telling us that, in FIG. 11(c), a UV/ozone induced process is indicated that removes intensity from the peak at about 3.56 eV and adds it to the peak at 1.51 eV These numeric labels of peak energy are calculated by fitting a parabola to the 5 points around the highest point in the peak. The process is, of course, some aspect of UV/ozone exposure, but the point is that this component reveals two of the peaks that make up the initial spectrum (b), and gives the energies of those peaks fairly accurately (within 0.06 eV) of the true value. The third component shown in FIG. 11(d) reveals another peak at about 2.53 eV (within 0.03 eV of where the real peak is) and again, one of the previously identified peaks at 1.53 eV, sufficiently close to the 1.51 eV previously identified to be sure it is the same chemical state. Therefore, FIGS. 9 to 11 show us that the UV/ozone effect of the present disclosure will allow the unique identification of the number of states and their energies (and fairly good estimates of their widths).

One could argue that this is an easy problem, because already the peaks shown in FIG. 9 are fairly well separated. They overlap, but there are three distinct peaks visible and one might, even by eye, estimate their energies as 1.5, 2.5 and 3.5 eV So consider now the case shown in FIG. 12, where I have reduced the separation of the peaks by giving them energies of 2 eV, 2.5 eV and 3 eV. They now overlap so much that the envelope (the continuous line in FIG. 12) has only a single local maximum. An inexperienced analyst may well attempt to fit this curve with a single peak, or a small number of peaks having various energies and intensities. Many alternative models fit reasonably well in the statistical sense, while making no chemical sense at all. This is the source of many of the errors in published peak fits discussed above in the Background section.

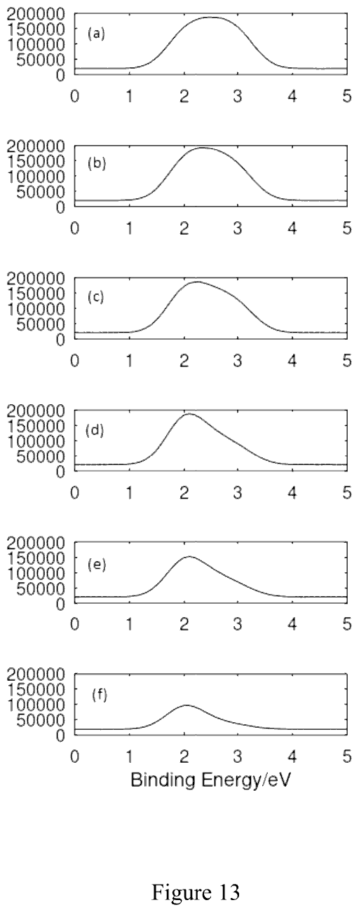

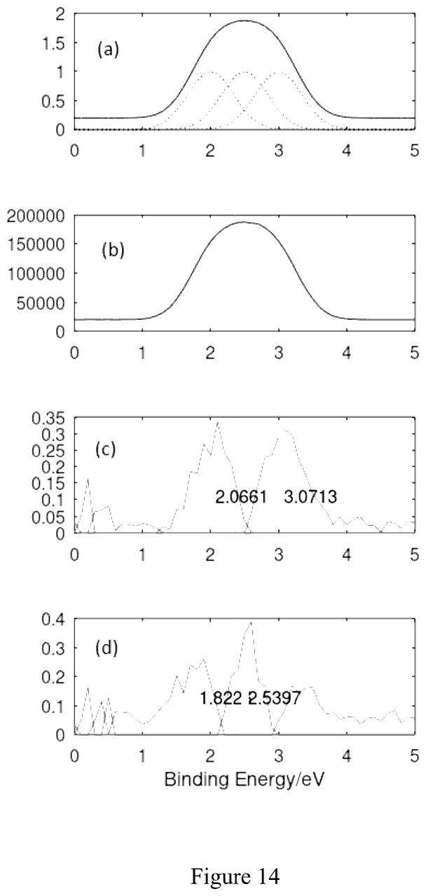

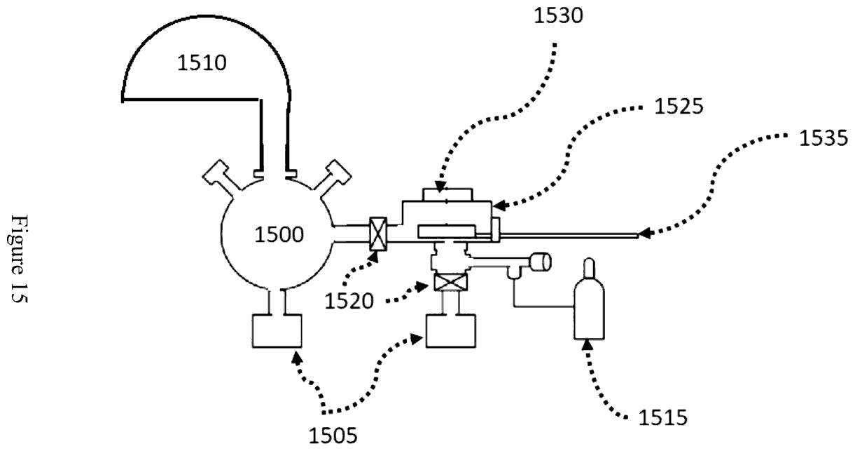

FIG. 13 shows how UV/ozone cleaning might affect the spectrum, as FIG. 10 did for the well-separated peaks. The spectra in FIG. 13 could be very confusing to someone new to XPS, and I have known inexperienced analysts interpret this sort of series of spectra as shifts in binding energy of a single peak, charging effects (even for conducting surfaces) or instrumental problems like voltage instabilities in the instrument. Yet SVD applied to the dataset in FIG. 14 gives a useful and robust answer; The initial spectrum has peaks at around 2.07 eV, 3.07 eV and 2.54 eV, all very close to the real values of 2, 3 and 2.5 eV. Given these energy values a conventional XPS peak fit becomes easy—this starting data for such a fit is very valuable and removes the ambiguities that can confuse people new to XPS.

Usage Procedure for this Disclosure (Reduction)

FIG. 24 gives a general procedure for using the spectrum acquisition usage of this disclosure.

Here the “hydrogen containing chamber” is the same as the sample enclosure discussed in the text, when filled with hydrogen.

FIG. 24 shows a flowchart for how spectrum acquisition is done with this disclosure. In some cases, the user will have enough information to set the UV/hydrogen exposure level/time in advance, without applying the question in this flowchart, giving a sequence of exposure steps of predetermined length. Otherwise the computer can, for example, perform PCA analysis of the spectra acquired to that point and recommend an increase to the exposure at the next step to make an observed difference in the spectra more likely.

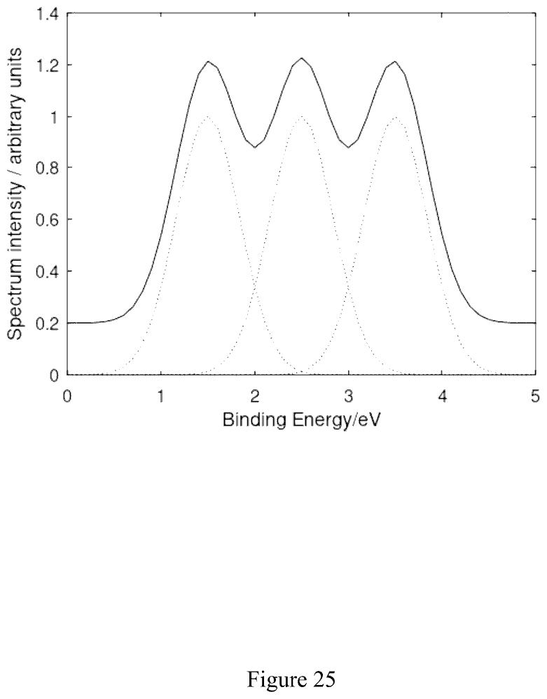

FIGS. 25 to 30 show numerical simulation results that demonstrate the effectiveness of the present disclosure. In FIG. 25 a synthetic spectrum is shown consisting of three peaks 1 eV apart. These can be resolved fairly easily in a modern spectrometer, so looking at the envelope spectrum (the continuous line in FIG. 25) it is clear that there are three peaks here at least. Note that, because C 1s peaks in XPS are typically on a fairly flat background I have included a background 20% of the height of the peaks and it is constant with energy.

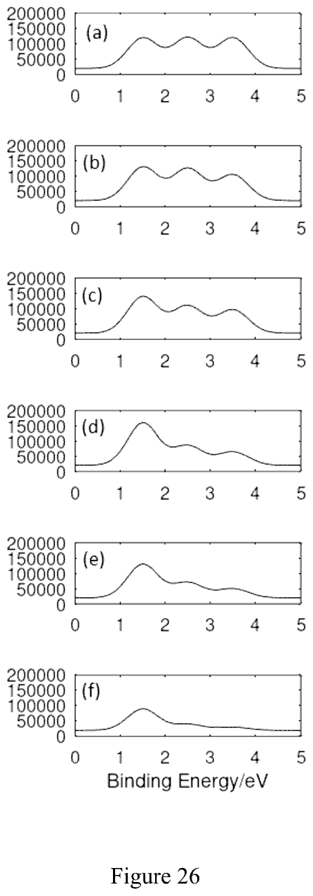

FIG. 26 shows simulated spectra after zero iterations (a), one iteration (b), two iterations (c) and so on of the procedure shown in FIG. 24. Each of FIGS. 26(b) to 26(f) therefore show the effect of more UV/hydrogen exposure than the previous one. Some states (i.e. peaks) fall in intensity more rapidly than others as we progress though this series. It does not matter whether the states that are removed more rapidly are at high or low binding energy, simply that the atoms that give rise to a peak in the spectrum can reappear in different chemical state in the next spectrum (or leave altogether after reaction with hydrogen to produce H₂O, for example).

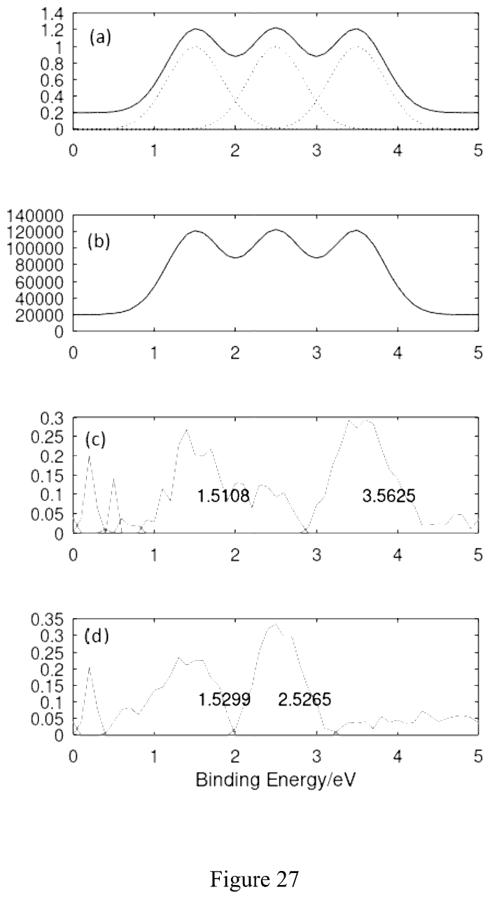

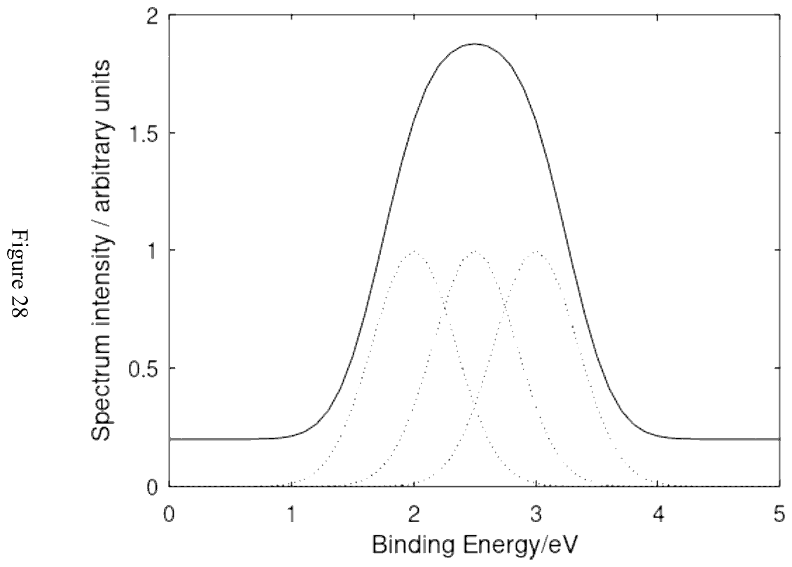

FIG. 27 shows the result of numerical processing of the simulated spectra shown in FIG. 26. FIG. 27(a) is a reminder of the peaks and their envelope as shown in FIG. 25. FIG. 27(b) shows the initial spectrum generated from this model with counts as the vertical axis and Poisson noise added. FIGS. 27(c) and 27(d) show the second and third components extracted from the set shown in FIG. 26 by using Singular Value Decomposition (SVD). The first component is not very useful as it simply resembles the average of the spectra shown in FIG. 26. The second and third (and in other real cases the higher components too) show important peak structures. Here I have inverted the negative parts of these components and plotted them in an unbroken line. The positive parts I have plotted in a dotted line. SVD is telling us that, in FIG. 27(c), a UV/hydrogen induced process is indicated that removes intensity from the peak at about 3.56 eV and adds it to the peak at 1.51 eV. These numeric labels are calculated by fitting a parabola to the 5 points around the highest point in the peak. The process is, of course, some aspect of UV/hydrogen exposure, but the point is that this component reveals two of the peaks that make up the initial spectrum (b), and gives the energies of those peaks fairly accurately (within 0.06 eV) of the true value. The third component shown in FIG. 27(d) reveals another peak at about 2.53 eV (within 0.03 eV of where the real peak is) and again, one of the previously identified peaks at 1.53 eV, sufficiently close to the 1.51 eV previously identified to be sure it is the same chemical state. Therefore, FIGS. 25 to 27 show us that the UV/hydrogen effect of the present disclosure will allow the unique identification of the number of states and their energies (and fairly good estimates of their widths).

One could argue that this is an easy problem, because already the peaks shown in FIG. 25 are fairly well separated. They overlap, but there are three distinct peaks visible and one might, even by eye, estimate their energies as 1.5, 2.5 and 3.5 eV So consider now the case shown in FIG. 28, where I have reduced the separation of the peaks by giving them energies of 2 eV, 2.5 eV and 3 eV They now overlap so much that the envelope (the continuous line in FIG. 28) has only a single local maximum. An inexperienced analyst may well attempt to fit this curve with a single peak, or a small number of peaks having various energies and intensities. Many alternative models fit reasonably well in the statistical sense, while making no chemical sense at all. This is the source of many of the errors in published peak fits discussed above in the Background section.

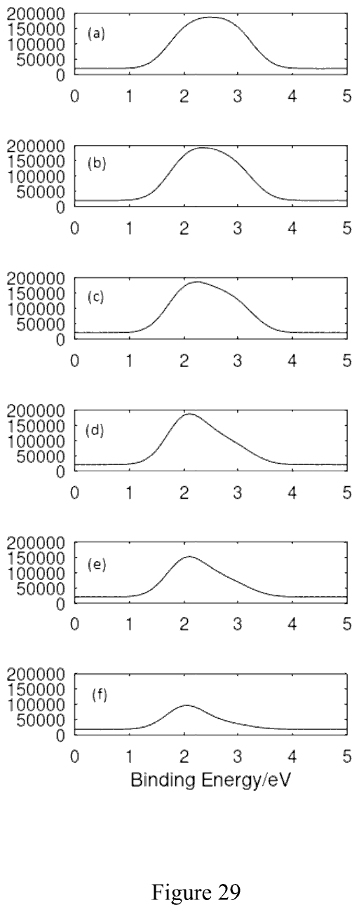

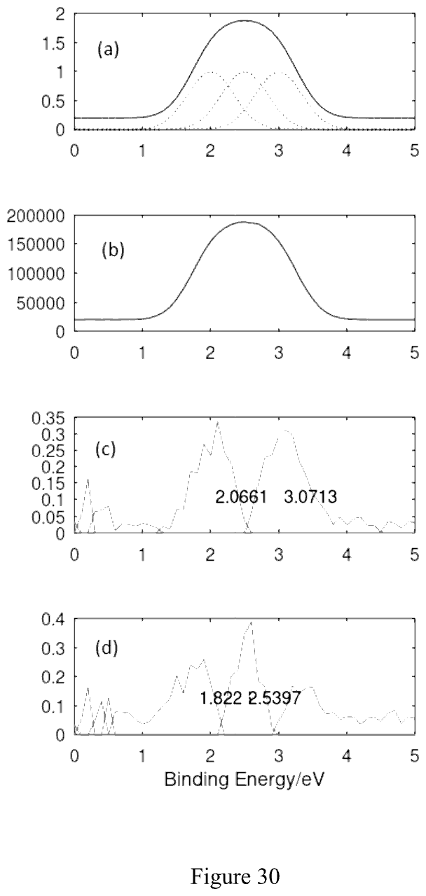

FIG. 29 shows how UV/hydrogen exposure might affect the spectrum, as FIG. 26 did for the well-separated peaks. The spectra in FIG. 29 could be very confusing to someone new to XPS, and I have known inexperienced analysts interpret this sort of series of spectra as shifts in binding energy of a single peak, charging effects (even for conducting surfaces) or instrumental problems like voltage instabilities in the instrument. Yet SVD applied to the dataset in FIG. 29 gives a useful and robust answer as shown in FIG. 30; The initial spectrum has peaks at around 2.07 eV, 3.07 eV and 2.54 eV, all very close to the real values of 2, 3 and 2.5 eV. Given these energy values a conventional XPS peak fit becomes easy—this starting data for such a fit is very valuable and removes the ambiguities that can confuse people new to XPS.

### Additional Ion-Beam Sputtering: Of the Sample

Optional ion-beam sputtering of the sample surface, before and/or after the UV/ozone/hydrogen exposures, can provide extra spectra useful for including in the PCA or machine learning dataset. This is because very short sputtering treatments, perhaps with monatomic argon ions at low kinetic energies (100 to 1,000 eV), is largely reducing in the sense of removing oxygen, but also damaging in the sense of producing chemical states that are rare in the as-received material. One can see that some specimens may be already highly oxidized in the state that they are received and for which we need analytical information. Further oxidation (by UV/ozone) changes the narrow-scan XPS spectra little. However, a light sputter before and/or after such oxidation can provide a wider range of spectra that allows better definition of the spectra of the chemical states present by using, for example, PCA.

### Possible Embodiments and Configurations (Oxidation of the Surface Layer)

FIG. 15 shows a schematic vertical cross-section through a typical commercial XPS instrument. There is an analysis chamber (1500) nominally at ultrahigh vacuum (UHV), with hemispherical electron energy analyzer (1510). Pumps (1505) maintain vacuum in the various parts of the system. Valves (1520) are opened and closed to allow a sample into the analytical chamber from the entry lock (1525). A transfer arm (1535) is used to move the sample between said analysis chamber and said entry lock. When withdrawing a sample from the system the entry lock is brought back up to atmospheric pressure by admitting gas (typically nitrogen) from cylinder (1515). The said entry lock typically has a transparent glass window (1530).

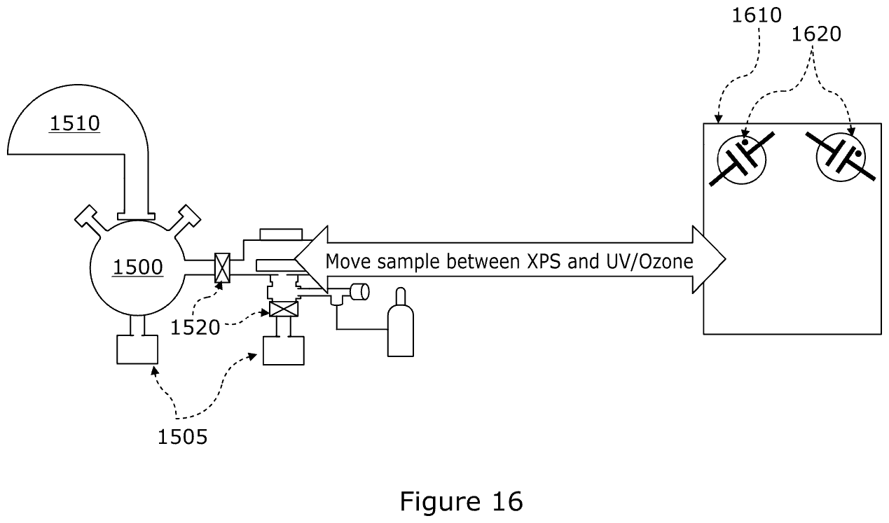

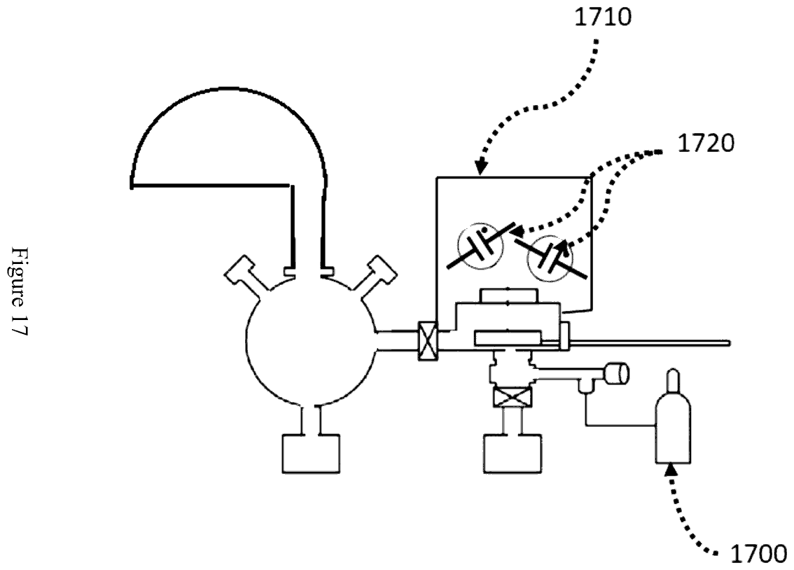

FIG. 16 shows one configuration of the present disclosure in which the XPS system and enclosure (as described above) are separate but in close proximity. The sample is moved, in air, from XPS system to said enclosure (1610) containing the UV/ozone producing lamps (1620), and back again after UV/ozone exposure, completing the iterative loop shown in FIG. 7. These transfers could be automated using a small air-side robot arm or similar, but are most likely to be done manually by the operator.

FIG. 17 shows another configuration of the present disclosure, in which the enclosure containing UV/ozone producing lamps is integrated with the XPS system entry lock. This requires a UV-transparent window on said entry lock instead of the usual glass window (1530) and the back-fill gas cylinder (1700) to contain oxygen or an oxygen-containing gas mixture (e.g. dry air) rather than pure nitrogen. UV passes through the said UV-transparent window and creates ozone within the entry lock itself.

When the sample is present in the entry lock it is therefore exposed to UV and ozone, and can be moved back into the analysis chamber for the next spectrum acquisition as described in the flowchart in FIG. 7. This configuration makes best use of automated sample handling, lamp and valve control; it would be possible, for example, for the whole of the sequence described in FIG. 7 to run as an automated sequence under computer control and without the need for a human operator to be present. It could run overnight, for example, making good use of instrument time that would otherwise be difficult to make good use of. In the morning the operator returns to find an entire set of spectra of the types shown in FIGS. 10 and 13, and calculated results of the type shown in FIGS. 11 and 14 already done (since the calculations need no operator knowledge or intervention).

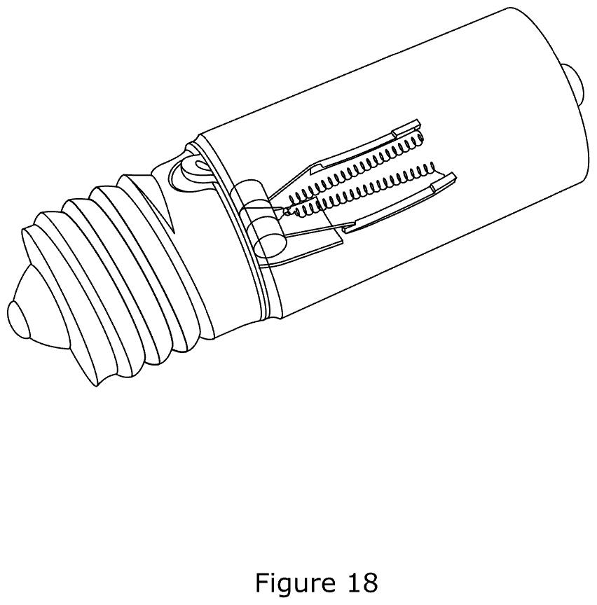

Regarding possible UV lamps that can be used in this application, I have had good results with small “GTL3” UV lamps of the type shown in FIG. 18, though many other models would probably work equally well. I have operated a lamp of this kind with a single 33 ohm ballast resistor and a supply voltage of 24V (a.c. and d.c. both work, though a.c. may lead to a longer lamp lifetime). In operation these lamps consume about 3 W at 10V (the remainder being dropped across the ballast resistor). Both ozone-emitting and non-ozone emitting versions of this lamp are available (they have different glass formulations to transmit, or block 185 nm radiation respectively), so that they can be used as one or both lamps A and B in FIG. 5. These have an E17 standard screw base, and are therefore easy to fit in a confined space. The Sankyo-Denki GTL3 is a 3 W lamp with 0.16 W UV output. Typical lifetime is specified by the manufacturer as 2000 hours. This lamp has an E17 screw base on the 20 mm diameter×63 mm long clear T7 tube. This item is made in Japan, and is also commonly available from Ushio, Fisher Scientific, Eiko, Hikari, American Ultraviolet, among many others, as part numbers GTL3 W, PO300-0350, 29-258-23, GRM0036, 3000022.

These GTL3 lamps are often used in germicidal applications, for example in washing-machines or toothbrush sanitizers. They are quite inexpensive, typically costing below US$10. They are not very efficient in electrical terms, especially if used with the 33 ohm ballast resistor, but that is not really a problem in this application. They do not have sufficient emission power to be used for UV/ozone cleaning of surfaces. Instead, larger mercury grid lamps are typically used for this. But as discussed above, for our application where we wish to oxidize or reduce the surface gently and progressively, these GTL3 lamps are sufficient if placed up to within about 10 cm of the sample. According to the specification, these lamps emit at 254 nm measured at a distance of 3 cm from the bulb, an ultraviolet intensity ≥450×10⁻⁶ W/cm². Though I cannot find any specifications for shorter wavelength emission, it is undoubtedly at 185 nm, and ozone is produced by these lamps.

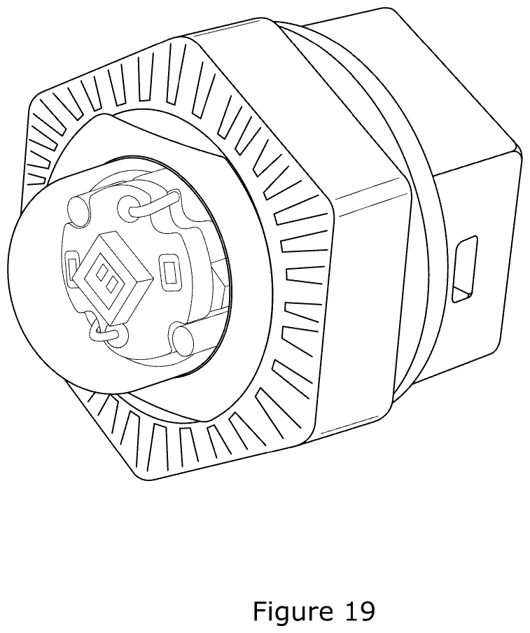

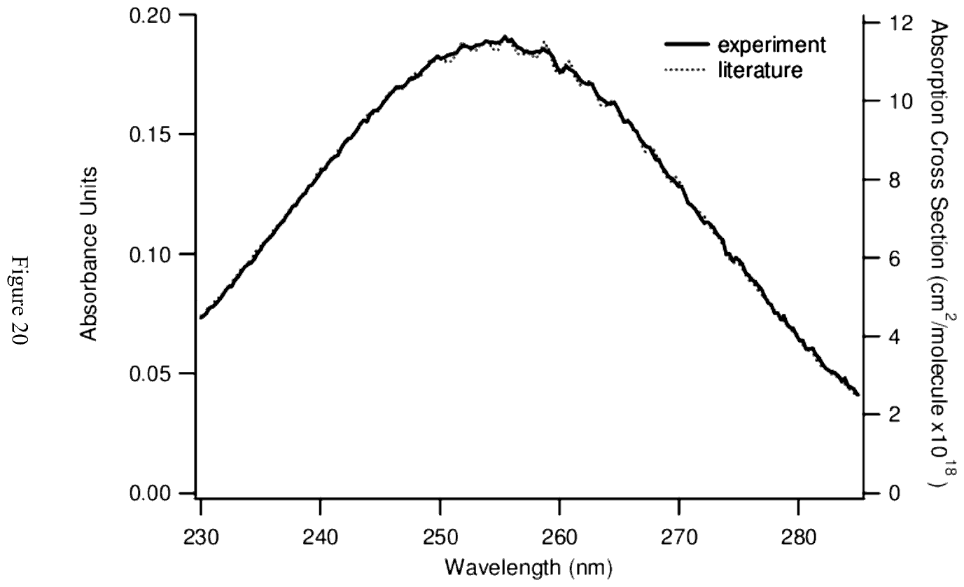

An alternative lamp for the longer wavelength lamp B is a shortwave light-emitting-diode (LED) such as that shown in FIG. 19. Currently these are available with wavelengths down to about 270 nm, so cannot be used as the ozone-creating lamp, but can be used as the ozone destroying one, or for illuminating the sample in the presence of hydrogen. With reference to FIG. 20, which shows the Hartley absorption band of ozone, one can see that the Hg vapor emission at 254 nm is close to the maximum absorption of ozone (and therefore causes it to return to diatomic oxygen rapidly) whereas at 270 nm LED emitters are less rapid, and therefore less efficient in terms of time-taken by a factor of around two if the photon intensities are similar, but more efficient in terms of electrical power used and probably lamp lifetime too.

The distance or range of operation (lamp to sample) in the present application is quite a difficult issue to decide theoretically because the two competing wavelengths emitted by UV lamps, 185 nm and 254 nm create and destroy ozone respectively¹⁸, so that the concentration of ozone with distance from the lamp decreases in a nonlinear way. For complicated enclosure geometries this is best determined experimentally with ozone and UV measurement devices, and those measurements can be expected to apply specifically to that particular enclosure and model of UV lamp(s).

### Possible Embodiments and Configurations (Reduction of the Surface Layer) Hydrogen-Releasing Element

Many laboratories that operate XPS instruments have high-purity hydrogen gas available. Others do not. In any case, when dealing with large quantities of hydrogen gas the costs of implementing safety procedures are often high, even if the quantities actually used (as in this application) are very small.

Therefore, optionally, and in some embodiments, we make use of hydrogen gas created in-situ within the sample enclosure by zinc-air or similar cell(s). These may be commercially available “button” cells, sold for devices such as hearing aids, that have replaced the mercury cells common twenty years ago. Indeed, variants of such cells have been made commercially-available for the purpose of hydrogen production.

Therefore, to provide a simple source of high-purity hydrogen gas, optionally the said zinc-air, or other metal-air type battery (which shall be understood to mean a cell or a plurality of cells) is located within the sample enclosure, with an external control over the current passing through that battery. When a resistive load is applied over zinc-air batteries without access to oxygen, they generate¹⁹ hydrogen gas at a fairly controllable rate²⁰. In one embodiment this may be achieved by having an external switch and resistor in series across the battery, so that switching-on will cause a resistor-limited current to pass through the battery.

This type of zinc-air battery is known to evolve a small quantity of hydrogen gas, roughly in proportion to the total charge that has passed through it. This allows hydrogen gas to be delivered to the region around the surface being analyzed to a partial pressure of around 10⁻³ mb or above, greater than the pressure of other reactive species (e.g. potentially oxidative species such as oxygen, water, etc.) in the sample enclosure.

Zinc-containing cells designed specifically for hydrogen production (such as those made²¹ by the Varta company) may be used—these are really modified forms of zinc-air battery marketed as precision hydrogen generators. The key consideration is that only small amounts of hydrogen are needed in this application, filling the small volume of a sample enclosure at what can be much less than atmospheric pressure, so that a zinc-air cell that produces perhaps 150 cm³ over its lifetime is quite sufficient. Four such cells in a battery will be able to deliver 600 cm³ over their lifetime, probably enough for >500 reduction cycles of low-pressure H₂ sample exposure under UV light before needing to be replaced.

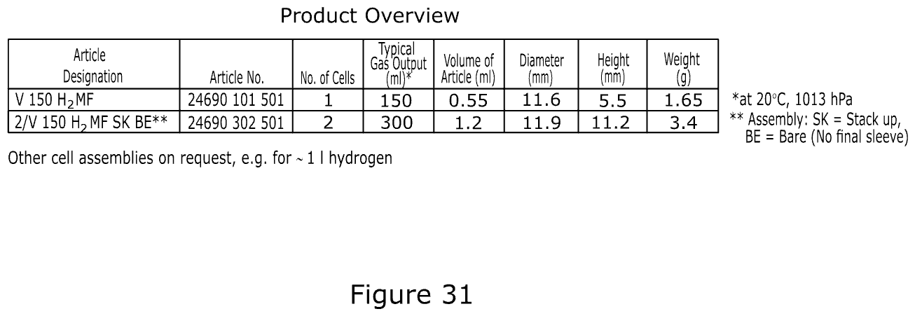

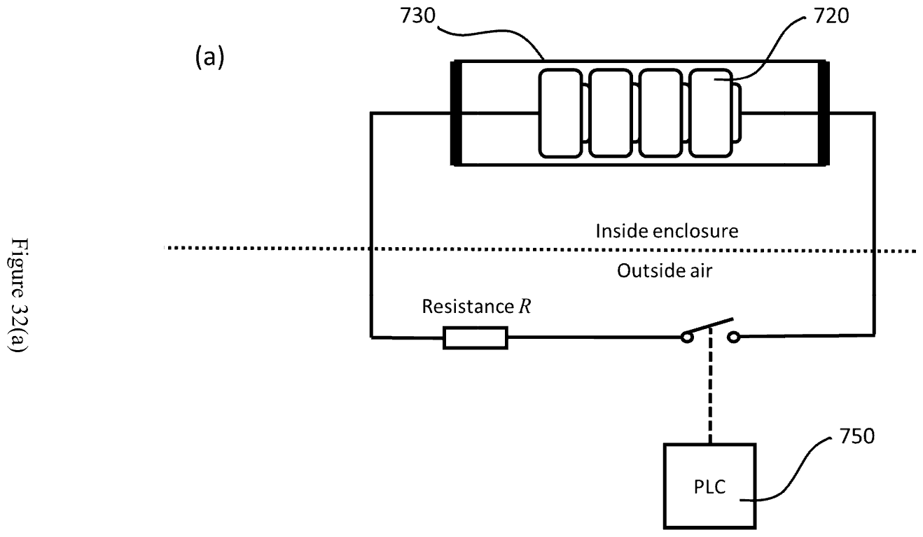

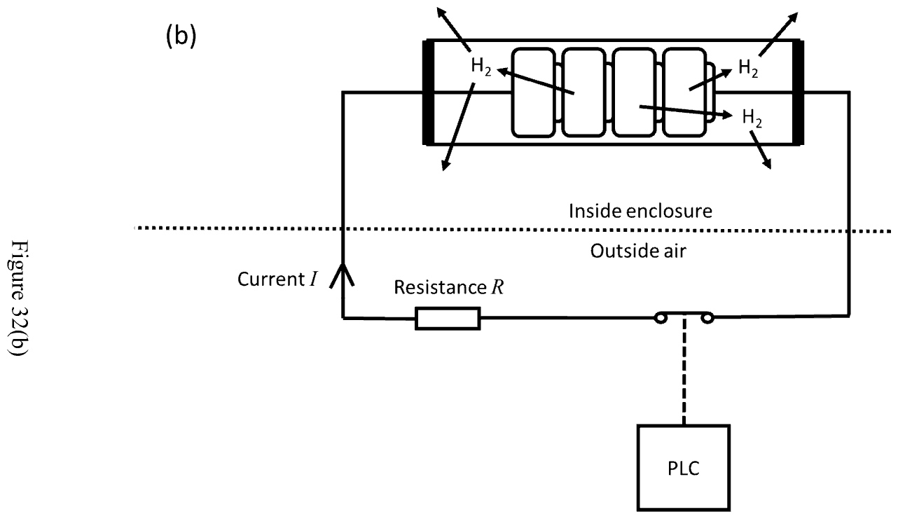

FIG. 31 shows a product overview for two battery cell products from the Varta company designed specifically to produce hydrogen.

The cells cannot be used unenclosed within a vacuum chamber (the sample enclosure) such as an XPS instrument entry-lock, because they contain an aqueous electrolyte. This will evaporate under dry conditions, and a vacuum is a very dry environment. Therefore, the cells must be enclosed by a container (the cell enclosure) within the sample enclosure that allows hydrogen gas out when required, but retains at least the partial-pressure of water at the operating temperature of the XPS instrument, e.g. about 18 mmHg at 20° C.

There are at least two possible embodiments that will achieve this cell enclosure;

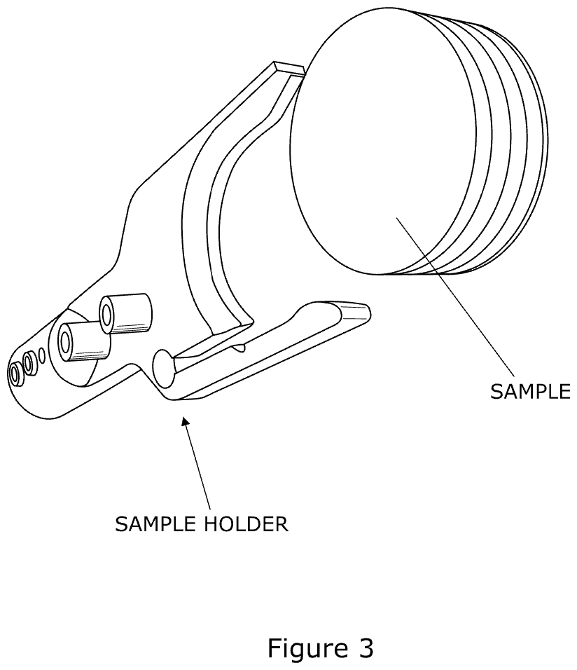

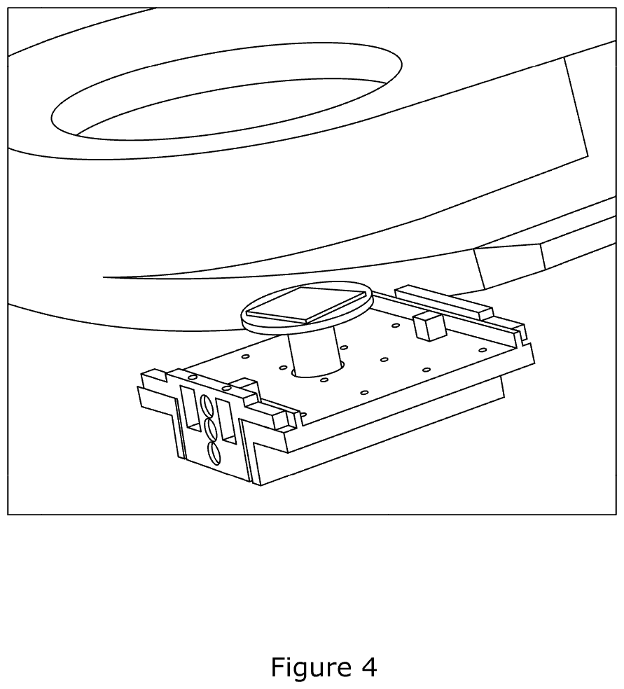

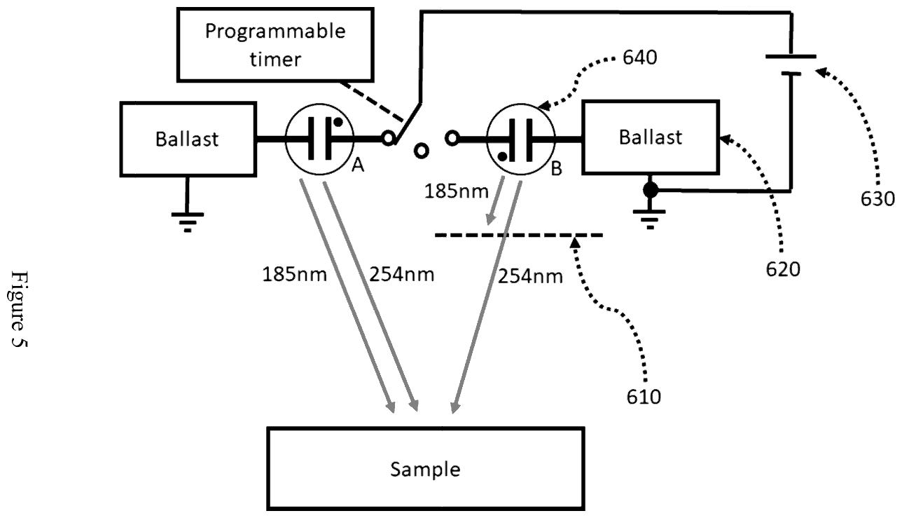

Possible cell enclosure embodiment A; A sealed tube around the cell(s) made from a hydrogen permeable (but water impermeable) material, such as palladium or palladium alloy. FIG. 3 shows a schematic of this arrangement, an optional embodiment in which four such cells are formed into a battery within a sealed palladium (or palladium alloy) tube that allows hydrogen to permeate out of it. Alternatively,

Possible cell enclosure embodiment B; A sealed tube around the cells connected to the main space of the entry-lock or other sample enclosure through a normally-closed pressure-relief valve that opens when the pressure inside (caused by hydrogen produced by the cell(s)) exceeds a predetermined value above the vapor-pressure of water at that temperature. For example, a spring-loaded relief valve set to open when the pressure inside the cell enclosure rises above 0.2 atm above the pressure outside, in the sample enclosure. Some water vapor will escape each time the valve opens, but in its normally-closed state, in the many hours between instances of use, the cell(s) will not dry out.

FIG. 32 shows schematically one possible embodiment A of the permeation hydrogen-releasing element of the present disclosure, FIG. 32(a) when de-selected, and FIG. 32(b) when selected to operate and release hydrogen.

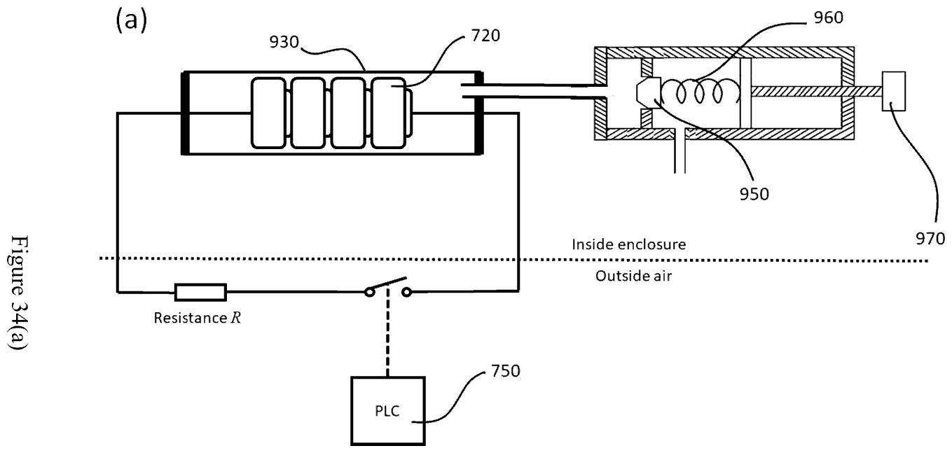

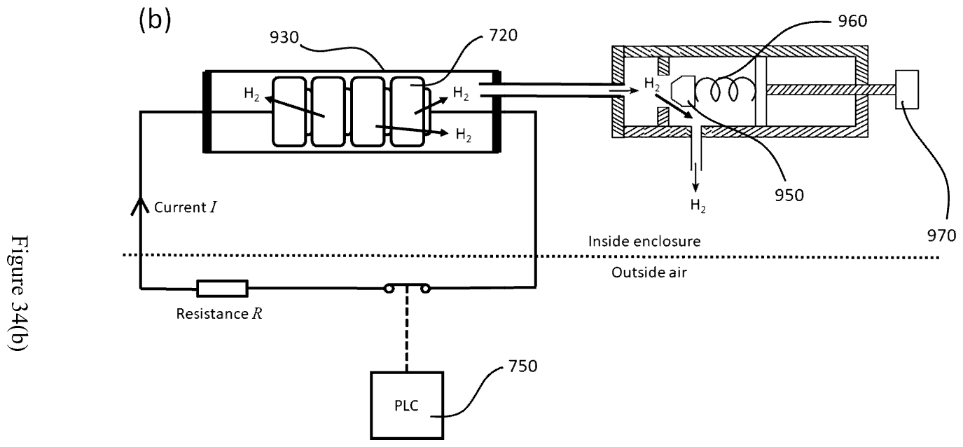

FIG. 33 shows a schematic of a simple embodiment type B of the cell enclosure. In FIG. 33, the prior chosen weight of the ball, 1020, in funnel, 1030 allows pressure within the cell enclosure 1010 to exceed that of the saturated vapor pressure of water at the operating temperature of the device (typically room temperature or slightly above) even though the sample enclosure pressure (not to be confused with the cell enclosure) may be a vacuum. This ensures that the cells, 720, do not dry out. Momentary pressing of the pushbutton discharges the capacitor, so that when the button is released current flows through the cells, generating hydrogen, until the capacitor is fully charged, releasing a fixed quantity of hydrogen predetermined by the choice of the capacitance value C. The pressure of hydrogen within the cell enclosure, 1010, being higher than the pressure within the sample enclosure around it then momentarily displaces the ball, 1020, releasing a small, fixed and predetermined quantity of pure hydrogen into the region around the sample in the sample enclosure for reduction, or UV-assisted reduction, of the sample surface. FIG. 34 shows schematically a slightly more sophisticated possible embodiment of cell enclosure type B, in both (a) dormant and (b) hydrogen-producing states. Here the switch controlling hydrogen production is normally open, as shown in (a), and may be a relay or similar switch under the control of the programmable logic controller (PLC), 750. The pressure around the cells, 720, within the cell enclosure, 930, is higher than inside the sample enclosure (not to be confused with the cell enclosure, 930) as a result of the pressure-relief valve formed by spring, 960, adjustment screw, 970, and “poppet”, 950. When, as shown in (h), the PLC closes the switch, d.c. current (limited by the resistor R to limit the rate of hydrogen production) passes through the cells, 720. The cells release hydrogen until this pressure on the poppet is enough to overcome the force of the spring, 960, and the hydrogen escapes into the sample enclosure. In this embodiment the computer-code being executed by the PLC may select different durations for the switch closure, thereby releasing different quantities of hydrogen into the region around the sample for subsequent reduction, or UV-assisted reduction, of the sample surface.

FIG. 15 shows a schematic vertical cross-section through a typical commercial XPS instrument. There is an analysis chamber (1500) nominally at ultra-high vacuum (UHV), with hemispherical electron energy analyzer (1510). Pumps (1505) maintain vacuum in the various parts of the system. Valves (1520) are opened and closed to allow a sample into the analytical chamber from the entry lock (1525). A transfer arm (1535) is used to move the sample between said analysis chamber and said entry lock. When withdrawing a sample from the system the entry lock is brought back up to atmospheric pressure by admitting gas (typically nitrogen or dry air) from cylinder (1515). The said entry lock typically has a transparent glass window (1530). FIG. 16 shows one configuration of the present disclosure in which the XPS system and sample enclosure (as described in paragraph above) are separate but in close proximity. The sample is moved, in air, from XPS system to said sample enclosure (1610) containing the UV producing lamp(s) (1620), and back again after UV/hydrogen exposure. Hydrogen is supplied to the sample enclosure 1610 either from a cylinder or other “piped” supply, or from the hydrogen-emitting cells by one of the embodiments described above and in FIG. 10, 11 or 12. These transfers could be automated using a small air-side robot arm or similar, but are most likely to be done manually by the operator.

FIG. 36 shows another embodiment of the present disclosure, in which the sample enclosure containing UV producing lamps is integrated with the XPS system entry lock. This requires a UV-transparent window on said entry lock (the location of this window is 1530 in FIG. 13). The back-fill gas cylinder (1700) may be used to supply hydrogen to the vicinity of the sample, or hydrogen-emitting cells, in their own cell-enclosure, 1780, may supply it (electrical connections and relief-valve are not shown). UV light passes through the said UV-transparent window into the entry lock itself.

When the sample is present in the entry lock it is therefore exposed to UV and hydrogen, and can be moved back into the analysis chamber for the next spectrum acquisition as described in the flowchart above. This configuration makes best use of automated sample handling, lamp and valve control; it would be possible, for example, for the whole of the sequence to be run under computer (and/or PLC) control and without the need for a human operator to be present. It could run overnight, for example, making good use of instrument time that would otherwise be difficult to make good use of. In the morning the operator returns to find an entire set of spectra.

Regarding possible UV lamps that can be used in this application, I have had good results with small “GTL3” UV lamps of the type shown in FIG. 16, though many other models would probably work equally well. I have operated a lamp of this kind with a single 33 ohm ballast resistor and a supply voltage of 24V (a.c. and d.c. both work, though a.c. may lead to a longer lamp lifetime). In operation these lamps consume about 3 W at 10V (the remainder being dropped across the ballast resistor). These have an E17 standard screw base, and are therefore easy to fit in a confined space. The Sankyo-Denki GTL3 is a 3 W lamp with 0.16 W UV output. Typical lifetime is specified by the manufacturer as 2000 hours. This lamp has an E17 screw base on the 20 mm diameter×63 mm long clear T7 tube. This item is made in Japan, and is also commonly available from Ushio, Fisher Scientific, Eiko, Hikari, American Ultraviolet, among many others, as part numbers GTL3 W, PO300-0350, 29-258-23, GRM0036, 3000022.

According to the specification, these lamps emit at 254 nm measured at a distance of 3 cm from the bulb, an ultraviolet intensity ≥450×10⁻⁶ W/cm². These GTL3 lamps are often used in germicidal applications, for example in washing-machines or toothbrush sanitizers. They are quite inexpensive, typically costing below US$10. They are not very efficient in electrical terms, especially if used with the 33 ohm ballast resistor, but that is not really a problem in this application. Indeed, waste heat from these lamp(s) could conceivably be used to heat the hydrogen-permeation cylinder or membrane to increase its permeability to hydrogen. An alternative lamp for the UV lamp is a shortwave light emitting-diode (LED).

Currently these are available with wavelengths down to about 270 nm.

### Closed-Loop Control

Using the signal from a hydrogen or pressure sensor in close proximity to the sample one can automatically control the hydrogen level to be maintained at the required value by switching on current through the zinc-air (or similar) battery.

### Interpretation of PCA, NMF or SVD Results

When a set of spectra (after progressive exposure of the sample to more and more UV/ozone or UV/hydrogen) is processed via a PCA or SVD algorithm, this can be viewed as one step on the way to extracting from that data the spectra of pure components. For example, by applying constraints that a combination of such components have;
1. No, or very small, negative-going features, and
2. Overall curvature of the spectrum is minimized

One can obtain automatically the spectra of the pure chemical components (typically several oxides of a metal for example) created and removed during UV/ozone treatment. Enforcing no, or very small, negative-going features leads to Non-negative Matrix Factorization or NMF.

Yet there is even more useful data present. One can regard each of these principal components as representing a chemical process occurring at UV/ozone or UV/hydrogen exposure. For example, a polymer may show a component with a negative peak at the binding energy of hydrocarbon, C—C*—C, and a positive peak at the binding energy of C*—OH. Once can interpret this as representing a chemical oxidation reaction. Yet the rate of such a reaction depends on the chemical environment of the carbon to begin with. Tn a specimen with different molecules (e.g. O or N as part of the polymer backbone) one could expect the rate of this reaction to be different, and therefore the sequence of UV/ozone treated specimen spectra to be different, and therefore the type (or ordering) of the principal components to be different. Therefore, this gives us access to more information that a single XPS spectrum alone cannot; for example, we may be able to distinguish a molecule with the SMILES code;
CCCCNCCCC
. . . from one with the SMILES code
CCCC(N)CCCC
. . . even though this would be difficult or impossible from looking at the chemical shifts in the spectra prior to UV/ozone exposure. Machine-learning algorithms such as neural network models or “deep learning” would be particularly useful when applied to stepwise UV/ozone and/or UV/hydrogen exposed specimen spectra as described here, even if the same algorithms reveal little when applied to just the spectra from the (not UV/ozone treated) specimen alone.

### Closed-Loop Control

Using the signal from an ozone sensor in close proximity to the sample one can automatically control the ozone level to be maintained at the required value by switching on lamps A (ozone producing) and B (ozone destroying) as labelled in FIG. 5. This can conveniently be done using an optical absorption or chemical ozone sensor and a proportional-integral-derivative (PID) controller to switch the lamps on or off (or in the case of being able to use LED devices, modulate their power output or duty cycle). Control of the ozone level allows one to shorten the time of some of the later, longer ozone exposure steps by raising the ozone level.

### Non-Conducting Samples

Non-conducting samples present a special problem, for which I have developed a special method to overcome.

In conventional XPS instrument operation a “flood gun” is typically used to obtain good spectra from non-conducting samples. This gun “floods” the sample with low-energy electrons and sometimes ions too, so that charges that accumulate on the sample surface are neutralized by these charged species. A charge balance is achieved, whereby photoelectrons leaving the surface leave a positive charge behind that is then neutralized by the charged particles emitted by the flood-gun. This charge balance does not necessarily return the surface to exactly earth potential, but stabilizes that potential somewhere close to earth potential. It is the stability of the surface potential that is most important for the acquisition of spectra. XPS operators quickly learn to recognize spectra in cases where charge-balance stability has not been achieved because peaks in the XPS spectrum are smeared over a range of energies, and sometimes don't look like peaks at all.

The problem for non-conducting samples when one applies the UV/ozone or UV/hydrogen exposure method described here is that successive exposures change the surface chemistry and consequently the charge-balance potential very slightly. This means that the peaks from the components of the sample appear to shift.

To remove the problem of charge-balance shifts I have had success in using ion-beam sputtered particles deposited onto the sample surface, which may be called Electrical Potential Marker Particles (EPMPs). These consist of a material that can be sputtered (by ion beam sputtering using the ion-gun built-in to almost all XPS systems) to cover a small fraction (perhaps 1 to 5%) of the sample surface with small particle clusters. This is done once, before the successive exposure steps to UV/ozone or UV/hydrogen. These particles then appear in all XPS spectra of the sample surface. The chemical composition of the EPMPs is chosen to provide a sharp peak that is then used to mark any change in the surface potential.

Ion-beam sputtering is possible for a wide range of materials, so many different materials could be used, in principle, to provide EPMPs. Further, the quantities of sputtered material are tiny in this application, so there is no real constraint of cost-even the most expensive precious metals would be acceptable if they performed well. So we must look carefully at the chemical properties of elements to see which might work best as EPMPs.

Clearly, a poor material choice is one that oxidizes as it is exposed to more ozone, especially if its oxide peaks are barely-resolved so that the progressive oxidation seems to shift the position of that monitored EPMP XPS peak. This makes Cu, for example, a poor choice.

Ideally, element X used as a sputter-target to provide EPMPs should have a single, constant oxidation state throughout progressive UV/ozone or UV/hydrogen exposure. This could he achieved by ensuring:
1. X oxidizes easily to its highest oxidation state, XOy, or
2. X is so noble that it does not oxidize at all, and remains in the metallic state as EPMPs despite ozone exposure,
3. X having XPS peak(s) close to C 1s and O 1s peaks, which are typically the most important in the analysis of most insulators. Proximity in energy means easier capture in a small number of XPS scans, and reduced likelihood of energy-scale drift causing significant errors.

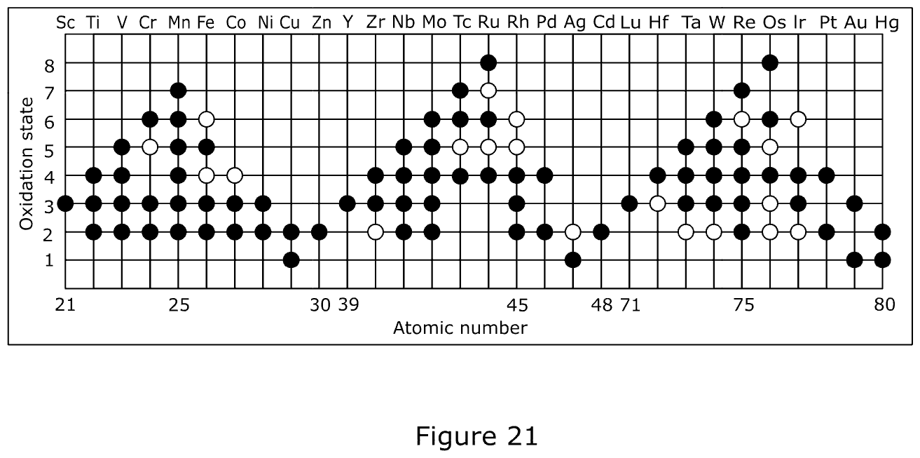

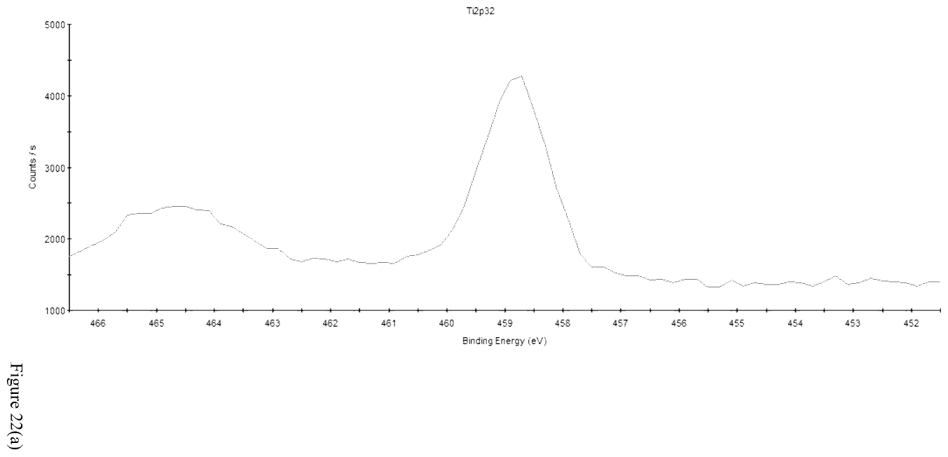

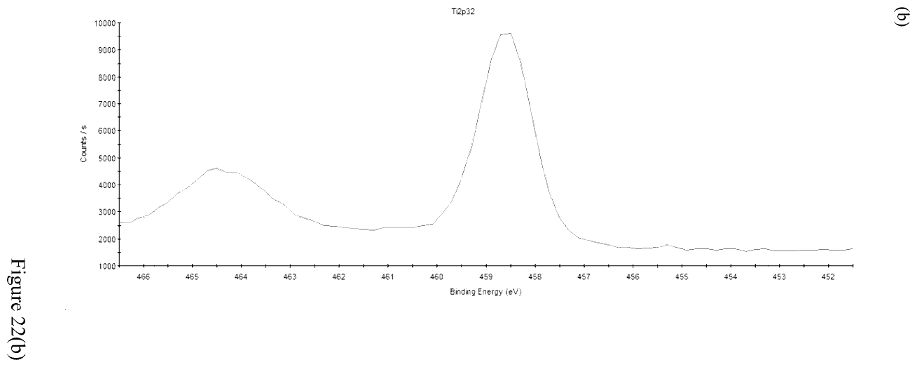

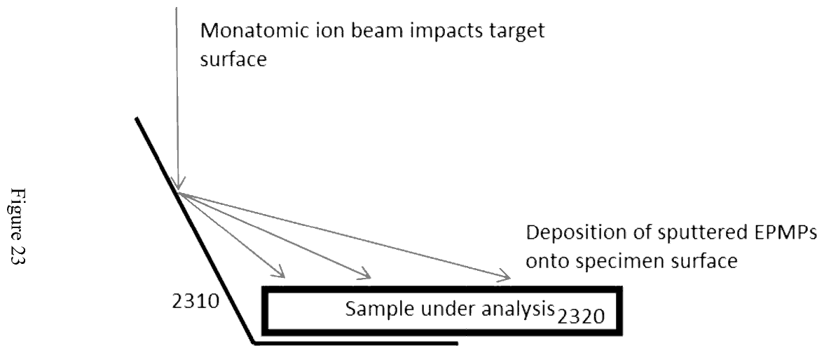

FIG. 21 is instructive. To form the best possible EPMPs the noble metals—for example even gold—is not “noble” enough. Exposed to ozone there are measurable apparent shifts in the Au 4f peaks due to gold oxide (and sometimes nitride) at the surface. Instead we should look at those elements that have few oxidation states and oxidize easily. Sc, Ti, Ni, Zn, Y, Cd, Lu, Hf may be reasonable candidates. Some may be difficult to justify handling on safety grounds (e.g. Cd). Ease of handling is also useful, so that widely-available and easily manipulated and malleable foils are an advantage.

1 have had good success with titanium in this application as a sputter target for the deposition of EPMPs. Titanium fulfills criterion 1 above, in being easily oxidized to its highest oxidation state. So much so that if one is trying to obtain an XPS spectrum of Ti metal one is typically frustrated by the appearance of surface oxide even in “ultra-high vacuum” conditions where there is a very small concentration of oxygen containing species (typically water). Indeed, Ti is used in sublimation pumps in XPS precisely for this reason—its affinity and high sticking coefficient for capture of oxygen containing species. Ti foil is widely-available in a variety of thicknesses and is easily formed into the right shape by bending. The most intense XPS peaks for Ti, Ti 2p peaks, lie roughly half-way in energy between C 1s and O 1s, which is ideal.

Peak position of the Ti 2p_{3/2} XPS peak may be determined with precision by many methods. I have used the polynomial fitting method²² I developed in the 1990s which works very well. All the spectra recorded from the specimen after a fixed UV/ozone or UV/hydrogen exposure are then shifted to ensure that the EPMP peaks coincide exactly, involving interpolation for integer numbers of channels shifted.

Deposition of EPMPs onto the Sample Surface

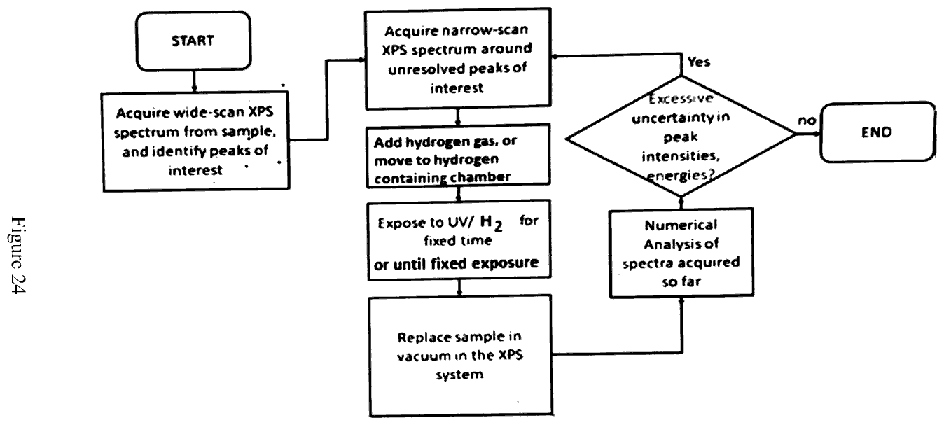

A small coupon of foil (in one embodiment titanium, as described above) is folded to have an internal angle of about 110°, as shown in FIG. 23. A beam of ions (typically argon, which may be clusters or monatomic as appropriate) is used to first clean the foil sputter target. This or another ion gun is then used to focus monatomic argon ions at the target foil surface and sputter atoms from the foil onto the sample. This sputter-deposition step is shown schematically (in cross-section) in FIG. 23, where particles that go on to form EPMPs arc sputtered from the target 2310 (typically Ti metal foil) onto the insulating sample under analysis 2320.

Typically the sputter deposition takes 1 to 2 minutes of ion-gun operating time. The Ti 2p_{3/2} peak should be at least 5% of the peak of the other strongest peaks in the spectrum. If this has not been achieved (as measured in a wide-scan spectrum of the specimen) then of course one can return to sputter more from the target 2310 until it is.

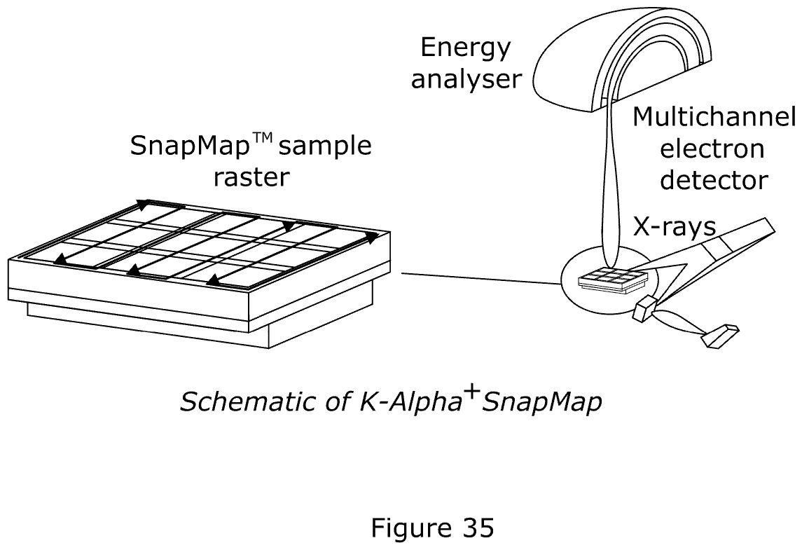

FIG. 35 illustrates an embodiment of the present disclosure where a sample is divided into a plurality of sub-samples s¹ to s⁹. This may be of use where a sample material is particularly uniform, such as a wafer of semiconductor material. The oxidation state of each sub-sample is changed by a different amount. Whilst each sample could be analyzed individually, it is possible, as shown in FIG. 35, to analyze a plurality of sub-samples contemporaneously.

### CITATION LIST

¹ Fred A Stevie and Carrie L Donley, Introduction to x-ray photoelectron spectroscopy, J. Va. Sci. Technol. A38, 063204 (2020) doi: 10.1116/6.0000412
² D R Baer et al, Practical guides for x-ray photoelectron spectroscopy: First steps in planning, conducting and reporting XPS measurements, J. Va. Sci. Technol. A37 (3), May/June 2019, 031401-1
³ G H Major et al, Assessment of the frequency and nature of erroneous x-ray photoelectron spectroscopy analyses in the scientific literature, J. Va. Sci. Technol. A38, 061204 (2020) doi: 10.1116/6.0000685
⁴ G H Major et al, Practical Guide for curve fitting in x-ray photoelectron spectroscopy, J. Vac. Sci. Technol. A38, 061203 (2020); doi: 10.1116/6.0000377.
⁵ https://srdata.nist.gov/xps/
⁶ FA Stevie et al, J. Vac. Sci. Technol. A38, 063202 (2020); doi: 10.1116/6.0000421
⁷ Kevin M McEvoy, Michel J. Genet and Christine Dupont, Principal Component Analysis: A Versatile Method for Processing and Investigation of XPS Spectra, September 2008, Analytical Chemistry 80 (19): 7226-38
⁸ https://en.wikipedia.org/wiki/Singular_value_decomposition
⁹ T. H. Fleisch, G. J. Mains, Reduction of copper oxides by UV radiation and atomic hydrogen studied by XPS, Applications of Surface Science, Volume 10, Issue 1, 1982, Pages 51-62, ISSN 0378-5963, https://doi.org/10.1016/0378-5963 (82) 90134-9.
¹⁰ Graeme Williams, Brian Seger, and Prashant V Kamat, TiO2-Graphene Nanocomposites. UV-Assisted Photocatalytic Reduction of Graphene Oxide, ACS Nano 2008, 2, 7, 1487-1491 https://doi.org/10.1021/nn800251f
¹¹ Deng, Sh., Lu, H. & Li, D. Y Influence of UV light irradiation on the corrosion behavior of electrodeposited Ni and Cu nanocrystalline foils. Sci Rep 10, 3049 (2020). https://doi.org/10.1038/s41598-020-59420-6
¹² Yit Lung Khung, Siti Hawa Ngalim, Andrea Scaccabarozzi and Dario Narducci, Beilstein J Nanotechnol. 2015; 6:19-26.
¹³ Waymouth, John (1971). Electric Discharge Lamps. Cambridge, MA: The M.I.T. Press. ISBN 978-0-262-23048-3.
¹⁴ H Amandusson, L.-G Ekedahl, H Dannetun, Hydrogen permeation through surface modified Pd and PdAgmembranes, Journal of Membrane Science, Volume 193, Issue 1, 2001, Pages 35-47, ISSN 0376-7388, https://doi.org/10.1016/S0376-7388(01)00414-8.
¹⁵ A. G. Knapton, Palladium Alloys for Hydrogen Diffusion Membranes, Platinum Metals Rev., 1977, 21, (2) p 44-50
¹⁶ Xueni Sun et al, Persistent adsorptive desulfurization enhancement of TiO2 after one-time ex-situ UV-treatment, Fuel 193 (2017) pp 95-100
¹⁷ John R. Vig, “UV/ozone cleaning of surfaces”, Journal of Vacuum Science & Technology A 3, 1027-1034 (1985) https://doi.org/10.1116/1.573115
¹⁸ The photodissociation of ozone in the Hartley band: A theoretical analysis, J. Chem. Phys. 123, 074305 (2005); https://doi.org/10.1063/1.2001650, Z.-W Qu, H. Zhu, S. Yu. Grebenshchikov, and R. Schinke
¹⁹ Shangwei Huang et al 2020 J. Electrochem. Soc. 167 090538
²⁰ Jeong, B. J.; Jo, Y. N. A Study on the Self-Discharge Behavior of Zinc-Air Batteries with CuO Additives. Appl. Sci. 2021, 11, 11675. https://doi.org/10.3390/app11241,1675
²¹ For example, Varta type V 150 H2 MF, see https://www.varta-ag.com/en/industry/5 product-solutions/hydrogen
²² Peter J. Cumpson, M. P. Seah and S. J. Spencer, Simple Procedure for Precise Peak Maximum Estimation for Energy Calibration in AES and XPS, September 1996, Surface and Interface Analysis 24 (10): 687-694 DOI: 10.1002/(SICI)1096-9918(19960930)24:103.0.C0;2-Q

1. A process for producing x-ray photoelectron spectra of a sample comprising the steps of:
producing a plurality of different oxidation states of the sample in a surface thereof by exposing the sample surface to an agent configured to change the oxidation state of the sample surface;
placing the sample in an x-ray photoelectron spectroscopy apparatus;
obtaining an x-ray photoelectron spectra for each of the plurality of oxidation states of the sample surface; and
identifying materials within the sample by analyzing the plurality of spectra.

2. A process according to claim 1, wherein the sample is exposed to the agent configured to change the oxidation state of the surface of the sample a plurality of times sequentially, wherein in each subsequent exposure of the sample to the agent, the oxidation state of the sample surface is changed relative to the oxidation state of the sample surface resulting from the preceding exposure to the agent configured to change the oxidation state of the said sample surface.

3. A process according to claim 1, wherein the sample is divided into a plurality of sub-samples each having a sub-sample surface, and wherein a different oxidation state of the sub-sample surface is produced for each sub-sample.

4. A process according to claim 1, wherein the agent configured to change the oxidation state of the sample surface is a gaseous agent.

5. A process according to claim 1, wherein the agent configured to change the oxidation state of the sample surface includes at least one selected from the group consisting of: ultraviolet light, ozone and hydrogen.

6. A process according to claim 5, wherein ultraviolet (UV) light is provided by at least one UV lamp, wherein UV light emitted from the at least one UV lamp is directed at said sample surface.

7. A process according to claim 6, wherein the UV light emitted from the at least one UV lamp is in the wavelength range 200 nm to 300 nm.

8. A process according to claim 6, wherein the UV lamp is a mercury vapor lamp.

9. A process according to claim 5, wherein ozone is provided by an ozone-producing device producing ozone gas at concentration in the range 0.01 to 20 parts-per-million in the gas around the sample.

10. A process according to claim 1, including the step of controlling the degree of change of the oxidation state of said sample surface by controlling at least one selected from the group consisting of: the time of exposure of the said sample surface to the agent; the concentration of the agent; and the wavelength and frequency of the agent.

11. A process according to claim 1, wherein the step of identifying materials within the sample by analysing analyzing the plurality of spectra includes performing multivariate analysis, using one selected from the group consisting of: principal component analysis and non-negative matrix factorization.

12. A device for capturing x-ray photoelectron spectra (XPS) configured to perform the process of claim 1, comprising:
a sample holder;
a source of the agent configured to change the oxidation state of a surface of a sample held in the sample holder;
means to control exposure of the sample surface to the agent configured to change the oxidation state of said surface; and
an x-ray photoelectron spectrometer capable of recording a plurality of XPS spectra, including one for each oxidation state of the sample surface.

13. A device according to claim 12, further comprising a data processor configured to perform one selected from the group consisting of: principal component analysis, and non-negative matrix factorization.

14. A device according to claim 12, wherein the sample holder is contained in an enclosure.

15. A device according to claim 12, wherein the agent configured to change the oxidation state of the sample surface is a gaseous agent.

16. A device according to claim 12, wherein the source of the agent configured to change the oxidation state of the sample surface is at least one selected from the group consisting of: ultraviolet light, ozone and hydrogen.

17. A device according to claim 16, wherein the ultraviolet (UV) light is provided by at least one UV lamp, wherein UV light emitted from the at least one UV lamp is directed at the sample surface.

18. A device according to claim 17, wherein the UV light emitted from the at least one UV lamp is in the wavelength range 200 nm to 300 nm.

19. A device according to claim 17, wherein the at least one UV lamp is mercury vapor lamp.

20. A device according to claim 16, further comprising an ozone generator configured to release ozone around the sample situated in the sample holder.

21. A device according to claim 20 wherein the ozone generator comprises at least one UV lamp emitting UV light in the wavelength range 100-300 nm in the air around the sample.

22. A device according to claim 21, wherein the at least one UV lamp emits UV light having a wavelength of at least one selected from the group consisting of: 185 nm and 254 nm.

23. A device according to claim 16, further comprising a hydrogen source configured to release hydrogen around the sample in the sample holder.

24. A device according to claim 23, wherein the hydrogen source is at least one zinc air cell.

25. A device according to claim 12, wherein the sample holder is adapted to hold a plurality of sub-samples, each sub-sample having a surface with a different oxidation state, and wherein the x-ray photoelectron spectrometer is configured to record XPS spectra for each of the sub-samples.
